(19) United States
(12) Patent Application Publication
(10) Pub. No.: US 2012/0306931 A1
(43) Pub. Date: Dec. 6, 2012

(54) SERVER DEVICE, CLIENT DEVICE, AND IMAGE TRANSFER SYSTEM

(75) Inventors: Mitsue Fujinuki, Kanagawa (JP); Takuya Kawamura, Kanagawa (JP)

(73) Assignee: KABUSHIKI KAISHA TOSHIBA, TOKYO (JP)

(21) Appl. No.: 13/420,826

(22) Filed: Mar. 15, 2012

(30) Foreign Application Priority Data
May 31, 2011 (JP) 2011-122402

(51) Int. Cl. G09G 5/00; G06K 9/54; G06F 15/16

(52) U.S. Cl. 345/672; 382/305; 345/619

(57) ABSTRACT

According to one embodiment, a server device that performs communication with a client device includes an obtaining unit, a storing unit, a comparing unit, and a sending unit. The obtaining unit is configured to obtain, from each of a plurality of pieces of image data generated in a sequential manner, a modification image representing an image portion which has got modified as compared to corresponding previous piece of image data. The storing unit is configured to store therein a specific image representing an image portion that is not to be displayed on the client device. The comparing unit is configured to compare the modification image with the specific image. The sending unit is configured to send, to the client device, the modification image not containing the specific image and not to send, to the client device, image portion in the modification image that match with the specific image.

### CROSS-REFERENCE TO RELATED APPLICATIONS

This application is based upon and claims the benefit of priority from Japanese Patent Application No. 2011-122402, filed on May 31, 2011; the entire contents of which are incorporated herein by reference.

### FIELD

Embodiments described herein relate generally to a server device, a client device, and an image transfer system.

### BACKGROUND

A typical image transfer system is known in which a server device transfers image data and a client device receives and displays the image data. With regard to such an image transfer system, a technique is known that allows the server device to hold the images that are not to be displayed on the client device (i.e., specific images) in a layer separate from a layer in which images to be shared with the client device (i.e., shared images) is held. Moreover, according to the technique, while the server device displays, on a screen thereof, images (composite images) each obtained by synthesizing a specific image and a shared image, it sends to the client device not the composite images but only the shared images. With the use of such technique, some of the images that are displayed on the server device can be restricted from being displayed on the client device.

In the technique described above, the server device generates the image data that is to be displayed on the screen thereof separately from the image data that is to be sent to the client device. That is, the server device generates two different sets of image data. That makes the functions required of the server device more complex. Moreover, the server device has a separate frame buffer for storing the image data that is to be displayed on the screen thereof and has a separate frame buffer for storing the image data that is to be sent to the client device. That leads to an increase in the amount of memory required to store all pieces of the image data. Consequently, the server device happens to have a complex configuration accompanied by an increased manufacturing cost.

### BRIEF DESCRIPTION OF THE DRAWINGS

FIG. 1 is a block diagram of an image transfer system according to a first embodiment;

FIG. 2 is a block diagram of an exemplary hardware configuration of a server device according to the first embodiment;

FIG. 3 is a block diagram of an exemplary functional configuration of the server device and a client device according to the first embodiment;

FIG. 4 is a diagram illustrating an example of a plurality of sets of image data generated in a sequential manner;

FIG. 5 is a diagram illustrating an example of a modification image that has been obtained;

FIG. 6 is a diagram illustrating another example of a modification image that has been obtained;

FIG. 7 is a flowchart for explaining an exemplary sequence in a screen information transfer operation according to the first embodiment;

FIG. 8 is a diagram for explaining a specific example of the screen information transfer operation according to the first embodiment;

FIG. 9 is a diagram for explaining another specific example of the screen information transfer operation according to the first embodiment;

FIG. 10 is a diagram for explaining still another specific example of the screen information transfer operation according to the first embodiment;

FIG. 11 is a diagram for explaining still another specific example of the screen information transfer operation according to the first embodiment;

FIG. 12 is a flowchart for explaining an exemplary sequence in a display operation according to the first embodiment;

FIG. 13 is a block diagram of an exemplary functional configuration of the server device and the client device according to a second embodiment;

FIG. 14 is a flowchart for explaining an exemplary sequence in a screen information generation operation according to the second embodiment;

FIG. 15 is a flowchart for explaining an exemplary sequence in a display operation according to the second embodiment;

FIG. 16 is a block diagram of an exemplary functional configuration of the server device, the client device, and a relay device according to a third embodiment;

FIG. 17 is a flowchart for explaining an exemplary sequence in the screen information transfer operation according to the third embodiment;

FIG. 18 is a diagram illustrating an example of the display position of the specific image;

FIG. 19 is a diagram illustrating another example of the display position of the specific image;

FIG. 20 is a diagram illustrating still another example of the display position of the specific image;

FIG. 21 is a diagram illustrating still another example of the display position of the specific image;

FIG. 22 is a diagram illustrating still another example of the display position of the specific image;

FIG. 23 is a diagram for explaining an exemplary method of generating image data;

FIG. 24 is a diagram for explaining an example of the method of generating image data;

FIG. 25 is a diagram for explaining another example of the method of generating image data;

FIG. 26 is a diagram illustrating an example of image data;

FIG. 27 is a diagram illustrating an example of a data table;

FIG. 28 is a diagram illustrating another example of image data; and

FIG. 29 is a diagram for explaining an example of the method of comparison.

### DETAILED DESCRIPTION

According to one embodiment, a server device that performs communication with a client device includes an obtaining unit, a storing unit, a comparing unit, and a sending unit. The obtaining unit is configured to obtain, from each of a plurality of pieces of image data generated in a sequential manner, a modification image representing an image portion which has got modified as compared to corresponding previous piece of image data. The storing unit is configured to store therein a specific image representing an image portion that is not to be displayed on the client device. The comparing unit is configured to compare the modification images with the specific image. The sending unit is configured to send, to the client device, the modification images not containing the specific image and not to send, to the client device, image portions in the modification images that match with the specific image.

Various embodiments will be described below in detail with reference to the accompanying drawings.

### A: First Embodiment

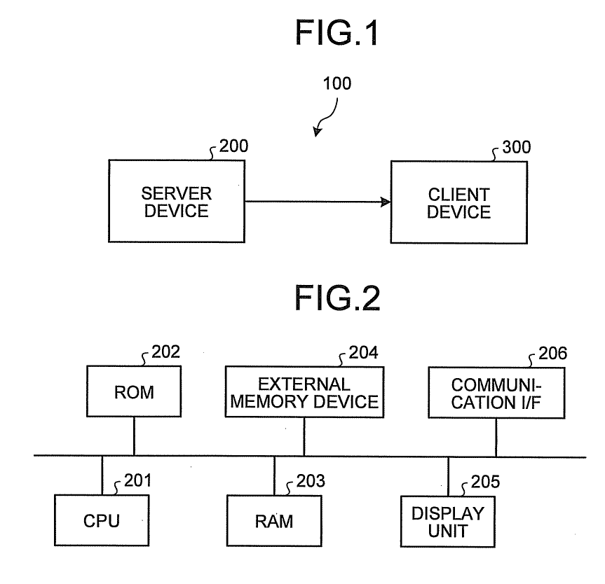

FIG. 1 is a block diagram of an exemplary overall configuration of an image transfer system 100 according to a first embodiment. As illustrated in FIG. 1, the image transfer system 100 includes a server device 200 and a client device 300, which performs communication with the server device 200. In the example illustrated in FIG. 1, the server device 200 and the client device 300 are connected to each other via a network. Herein, the type of network is not restricted to any particular type. That is, the network can be a local area network (LAN) or can be the Internet. Moreover, in the example illustrated in FIG. 1, only a single client device 300 is illustrated. However, that is not the only possible case, and any number of client devices 300 can perform communication with the server device 200. Thus, the configuration can be such that two or more client devices 300 perform communication with the server device 200.

FIG. 2 is a block diagram of an exemplary basic hardware configuration of the server device 200. As illustrated in FIG. 2, the server device 200 represents a computer that includes a central processing unit (CPU) 201, a read only memory (ROM) 202, a random access memory (RAM) 203, an external memory device 204, a display unit 205, and a communication interface (I/F) 206.

The CPU 201 reads predetermined control programs from the ROM 202, loads them in the RAM 203, and executes them to control the server device 200 in entirety. The ROM 202 is a nonvolatile semiconductor memory that is used in storing control programs or a variety of data. The RAM 203 is a volatile semiconductor memory that is used in temporarily storing a variety of data at the time of execution of various computer programs stored in the ROM 202. The external memory device 204 is a nonvolatile semiconductor memory such as a hard disk drive (HDD) that is used in storing a variety of data. The display unit 205 is, for example, a liquid crystal panel that displays various images generated by the server device 200. The communication I/F 206 is an interface device for communicating with the client device 300. Meanwhile, the basic hardware configuration of the client device 300 is identical to the configuration example illustrated in FIG. 2. Hence, the detailed explanation of the basic hardware configuration of the client device 300 is given.

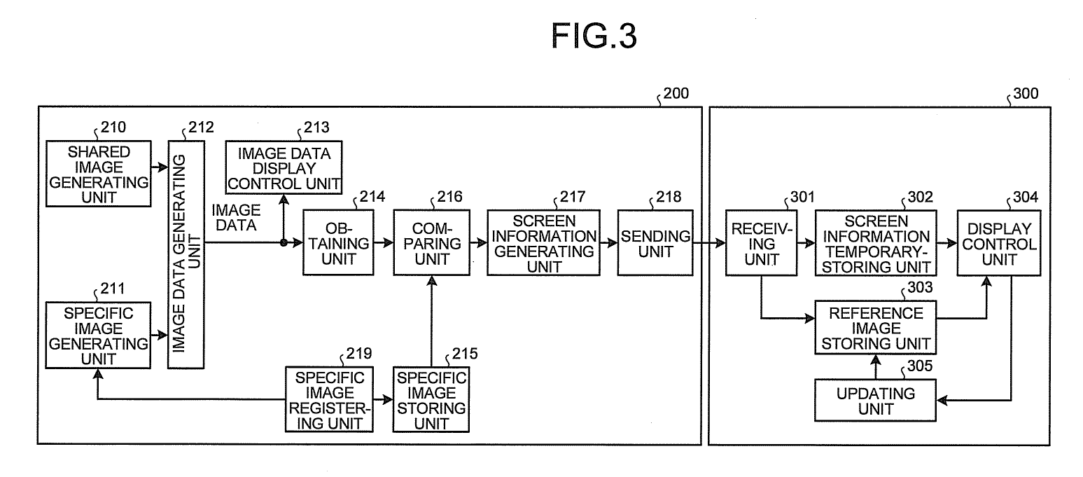

FIG. 3 is a block diagram of an exemplary functional configuration of the server device 200 and the client device 300 according to the first embodiment. As illustrated in FIG. 3, the functions of the server device 200 include a shared image generating unit 210, a specific image generating unit 211, an image data generating unit 212, an image data display control unit 213, an obtaining unit 214, a specific image storing unit 215, a comparing unit 216, an screen information generating unit 217, a sending unit 218, and a specific image registering unit 219.

For each frame period that indicates the period in which an image of a single frame is generated, the shared image generating unit 210 generates an image that is to be displayed on the server device 200 as well as on the client device 300 in a shared manner (i.e., generates a shared image), and sends that shared image to the image data generating unit 212.

For each frame period, the specific image generating unit 211 generates an image that is not to be displayed on the client device 300 (i.e., generates a specific image), and sends the specific image to the image data generating unit 212 along with specification information that specifies the display position (i.e., the position on a screen) of the specific image.

For each frame period, the image data generating unit 212 generates image data of a single frame by superimposing the specific image, which is generated by the specific image generating unit 211, at the display position specified in the specification information on the shared image, which is generated by the shared image generating unit 210. Then, the image data generating unit 212 sends the generated image data to the image data display control unit 213 and the obtaining unit 214. Upon receiving the image data from the image data generating unit 212, the image data display control unit 213 displays the image data on a display screen of the server device 200 (i.e., on the display unit 205).

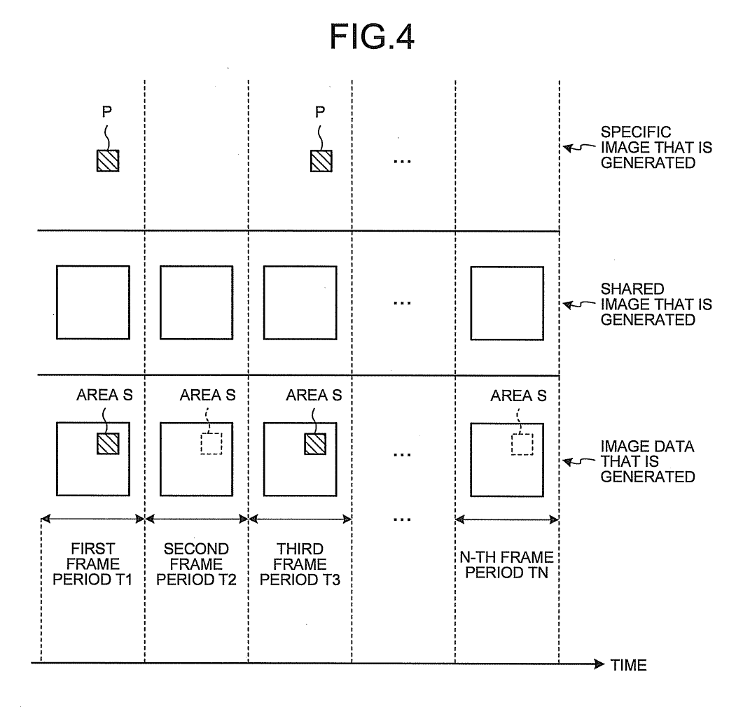

In the first embodiment, the image data generating unit 212 generates a plurality of pieces of image data in a sequential manner in such a way that the specific image is displayed in a specific area in a flashing manner. More particularly, assume that the image data generating unit 212 generates N pieces of image data (where N is an integer equal to or more than one). As illustrated in FIG. 4, the period for which the N pieces of image data are generated includes N frame periods T1 to TN. In each of the N frame periods T1 to TN, the image data generating unit 212 generates image data using the shared image and the specific image that are generated in the corresponding frame period T.

In each of the N frame periods T1 to TN, the shared image generating unit 210 generates a shared image. In the example illustrated in FIG. 4, in each frame period T, the same image is generated as the shared image (details not illustrated) at the same display position. In contrast, the specific image generating unit 211 generates a specific image P only in the odd-numbered (or only in the even-numbered) frame periods T. As an example, in each odd-numbered frame period T, the specific image generating unit 211 generates the specific image P that is displayed in an area S of image data. Thus, as illustrated in FIG. 4, although the specific image P gets displayed in the area S of the image data generated in the odd-numbered frame periods T, the image data generated in the even-numbered frame periods T does not have the specific image P displayed therein. Consequently, on the display screen (not illustrated) of the server device 200, the image data having the specific image P displayed in the area S in a flashing manner gets displayed.

From each of the plurality of pieces of image data provided in a sequential manner by the image data generating unit 212, the obtaining unit 214 obtains a modification image that represents an image portion which has got modified as compared to the corresponding previous piece of image data. In the first embodiment, the obtaining unit 214 obtains modification images as well as the positions (i.e., positions on the screen) of those modification images. Herein, the explanation is given for a case when the obtaining unit 214 receives the image data generated in the third frame period T3 illustrated in FIG. 4. Of the image data generated in the third frame period T3, the image portion that has got modified as compared to the previous image data (i.e., the image data generated in the second frame period T2) points to the area S illustrated in FIG. 4. Thus, the image portion displayed in the area S (in this case, the specific image P) is obtained as the modification image.

Returning to the explanation with reference to FIG. 3, the specific image storing unit 215 is used to store the specific images. In the first embodiment, the specific image storing unit 215 stores therein the specific images along with specification information that specifies the display positions (i.e., the positions on the screen) of those specific images.

The comparing unit 216 compares a modification image obtained by the obtaining unit 214 with a specific image stored in the specific image storing unit 215. In the first embodiment, the comparing unit 216 performs the comparison by referring to a specific image as well as to the corresponding specification information. More particularly, the comparing unit 216 compares a specific image with the image displayed in an area of the modification image which is specified in the specification information. The method of comparison is not restricted to any particular method. As an example, the comparing unit 216 selects an arbitrary number of pixels from the pixels of an image portion displayed in the area of the modification image which is specified in the specification information, and compares pixel values of the selected pixels with pixel values of the corresponding pixels in the specific image. If all pixel values are matching, then the comparing unit 216 determines that the specific image matches with the image portion displayed in the area of the modification image which is specified in the specification information. Meanwhile, alternatively, the comparing unit 216 can compare only images without taking into consideration the display positions. In that case, the specification information becomes redundant and need not be stored in the specific image storing unit 215.

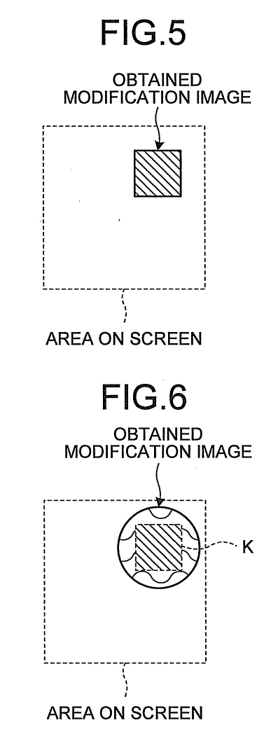

Consider a case when a modification image illustrated in FIG. 5 is obtained. In the example illustrated in FIG. 5, it is assumed that the area on the screen in which the modification image is displayed is completely overlapping (matching with) the area specified in the specification information, which is stored in the specific image storing unit 215, and that the image in the specified area is also matching with the specific image. In this case, the position, the size, and the image portion of the modification image that has been obtained match with the position, the size, and the image portion of the specific image. Hence, it can be said that the modification image that has been obtained completely matches with the specific image stored in the specific image storing unit 215. Next, consider a case when a modification image illustrated in FIG. 6 is obtained. In the example illustrated in FIG. 6, the area specified in the specification information is referred to as an area K and is included in an area of the screen in which the modification image is displayed. In the example illustrated in FIG. 6, of the modification image, the image portion displayed in the area K matches with the specific image. Thus, in this case, it is determined that, of the modification image, the image portion displayed in the area K matches with the specific image but the image portion displayed in the area other than the area K does not match with the specific image.

The screen information generating unit 217 refers to the comparison result obtained by the comparing unit 216 and generates screen information, which contains the image portion of the modification image that does not match with the specific image and which contains position information indicating the position (i.e., the position on the screen) of the non-matching image portion. For example, when the modification image that has been obtained completely matches with the specific image as illustrated in FIG. 5, the screen information generating unit 217 does not generate screen information. In contrast, as illustrated in FIG. 6, consider the case when it is determined that, of the modification image, the image portion displayed in the area K matches with the specific image but the image portion displayed in the area other than the area K does not match with the specific image. In that case, the screen information generating unit 217 generates screen information that contains the image portion displayed in the area other than the area K and contains position information of the image portion.

The sending unit 218 sends the screen information, which is generated by the screen information generating unit 217, to the client device 300. Moreover, from the image data generating unit 212, the sending unit 218 obtains a reference image (a default reference image) that points to an image present immediately before starting the display of the specific image (herein, an image present immediately before starting the change in flashing) and sends the obtained reference image in advance to the client device 300. Besides, the reference image is also stored in a memory (not illustrated) in the server device 200 and is used in obtaining the initial modification image.

The specific image registering unit 219 registers a specific image in the specific image storing unit 215. For example, during the initial settings, the specific image registering unit 219 can be configured to obtain a specific image along with the specification information indicating the display position of the specific image from the specific image generating unit 211, and to register the specific image and the specification information in the specific image storing unit 215. When the specific image generating unit 211 is not in the active state, the specific image registering unit 219 can be configured to obtain a default specific image, which is set in advance, along with the corresponding specification information from a memory (not illustrated), and to register the default specific image and the specification information in the specific image storing unit 215.

In the server device 200, the CPU 201 reads control programs from the ROM 202, loads them in the RAM 203, and executes them so as to implement the functions of the shared image generating unit 210, the specific image generating unit 211, the image data generating unit 212, the image data display control unit 213, the obtaining unit 214, the comparing unit 216, the screen information generating unit 217, the sending unit 218, and the specific image registering unit 219. However, that is not the only possible case. Alternatively, at least some of those functions can be implemented using individual circuits (hardware). Meanwhile, the specific image storing unit 215 is implemented using hardware and is installed in at least one of a ROM, a RAM, and an external device.

As illustrated in FIG. 3, the functions of the client device 300 include a receiving unit 301, a screen information temporary-storing unit 302, a reference image storing unit 303, a display control unit 304, and an updating unit 305.

The receiving unit 301 receives the screen information and the reference image that has been transferred from the server device 200. The screen information temporary-storing unit 302 stores therein the screen information received from the server device 200. The reference image storing unit 303 stores therein the reference image received from the server device 200. The display control unit 304 refers to the screen information, which is stored in the screen information temporary-storing unit 302, and the reference image, which is stored in the reference image storing unit 303; and generates display image data that represents the image to be displayed on the client device 300. Then, the display control unit 304 displays the display image data on a display screen (not illustrated) of the client device 300.

The updating unit 305 updates the reference image stored in the reference image storing unit 303. More particularly, every time the display control unit 304 generates the display image data, the updating unit 305 updates the reference image stored in the reference image storing unit 303 to the display image that is generated. As a result, the reference image that is stored in the reference image storing unit 303 can be set to the image data that is present immediately before the modification in the image indicated in the latest screen information.

In the client device 300, a CPU reads control programs from a ROM, loads them in a RAM, and executes them so as to implement the functions of the receiving unit 301, the display control unit 304, and the updating unit 305. However, that is not the only possible case. Alternatively, at least some of those functions can be implemented using individual circuits (hardware). Meanwhile, the screen information temporary-storing unit 302 and the reference image storing unit 303 are implemented using hardware and are installed in at least one of a ROM, a RAM, and an external device.

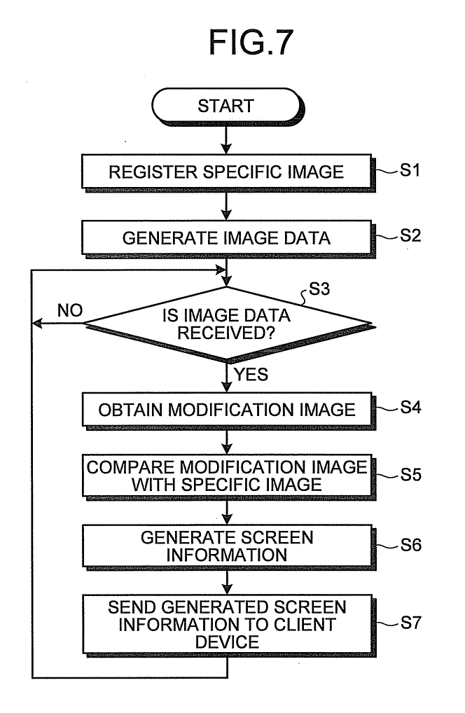

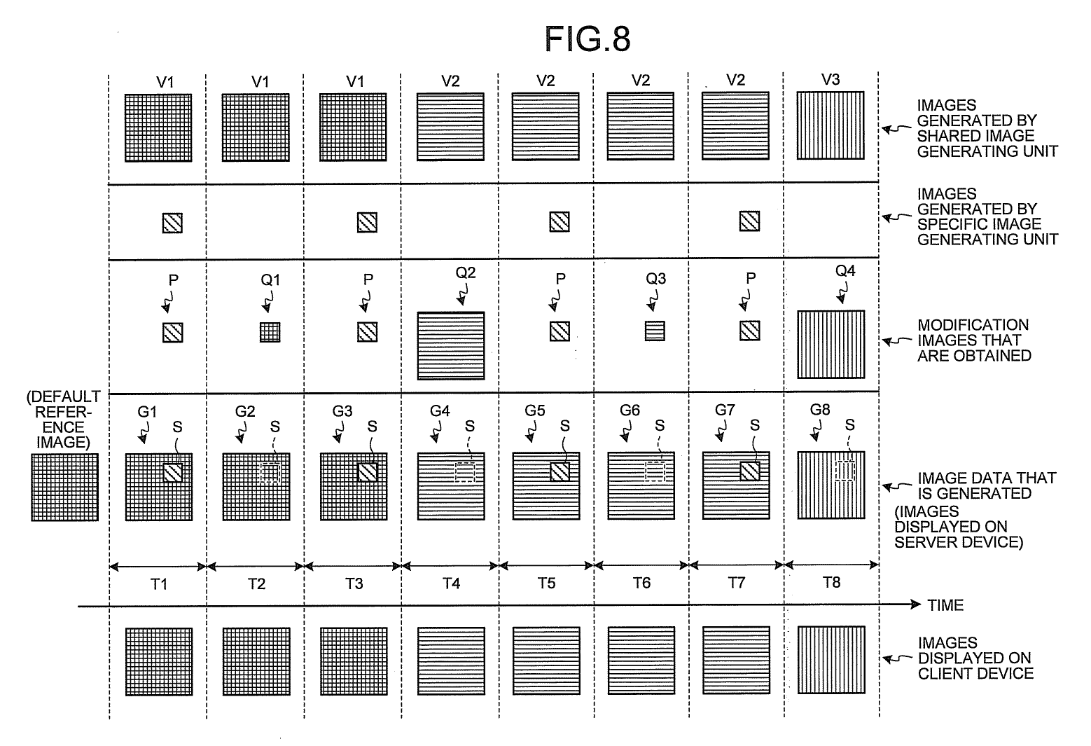

Explained below is an example of operations performed by the server device 200. In the first embodiment, the server device 200 performs a screen information transfer operation for transferring (sending) the screen information to the client device 300. FIG. 7 is a flowchart for explaining an exemplary sequence in the screen information transfer operation performed by the server device 200. Thus, the following explanation regarding the screen information transfer operation is given with reference to FIG. 7.

Firstly, the server device 200 registers a specific image in the specific image storing unit 215 (Step S1). The detailed explanation is as follows. When the specific image generating unit 211 is in the active state, the specific image registering unit 219 obtains a specific image and the corresponding specification information, which specifies the display position of that specific image, from the specific image generating unit 211; and registers the specific image and the specification information in the specific image storing unit 215. On the other hand, when the specific image generating unit 211 is not in the active state, the specific image registering unit 219 obtains a predetermined default specific image and the corresponding specification information from a memory (not illustrated), and registers the default specific image and the corresponding specification information in the specific image storing unit 215. However, these are not the only possible cases and the registration of a specific image can be performed in an arbitrary manner. In essence, as long as the specific image is stored in the specific image storing unit 215, the purpose is served.

Then, the image data generating unit 212 generates a plurality of pieces of image data in a sequential manner (Step S2). As described earlier, in the first embodiment, the image data generating unit 212 generates a plurality of pieces of image data in a sequential manner in such a way that the specific image is displayed in a specific area in a flashing manner, and sends the generated image data to the obtaining unit 214. Upon receiving a piece of image data from the image data generating unit 212 (Yes at Step S3), the obtaining unit 214 extracts, from the received piece of image data, the portion (area) that has got modified as compared to the corresponding previous pieces of image data and obtains the image displayed in the extracted portion as the modification image (Step S4).

Then, the comparing unit 216 compares the modification image obtained at Step S4 with the specific image (Step S5). Subsequently, the screen information generating unit 217 refers to the comparison result obtained at Step S5 and accordingly generates screen information (Step S6). For example, when only a portion of the modification image matches with the specific image, the screen information generating unit 217 generates screen information which contains the image portion of the modification image that does not match with the specific image and which contains position information of that image portion. Moreover, for example, when the modification image obtained at Step S4 completely matches with the specific image (matches in position, size, and image portion); then the screen information is not generated. In that case, no screen information is transferred to the client device 300. Subsequently, the sending unit 218 sends the screen information generated at Step S6 to the client device 300 (Step S7). With that, the system control returns to Step S3.

As an example, as illustrated in FIG. 8, assume that the image data generating unit 212 generates eight pieces of image data G1 to G8 in a sequential manner in such a way that the specific image P is displayed in the specific area S in a flashing manner. The period during which the eight pieces of image data G1 to G8 are generated is divided into eight frame periods T1 to T8. In the example illustrated in FIG. 8, an image V1 is generated as the shared image in the frame periods T1 to T3; an image V2 is generated as the shared image in the frame periods T4 to T7; and an image V3 is generated as the shared image in the frame period T8. Herein, it is assumed that the default reference image is same as the image V1. Moreover, in the example illustrated in FIG. 8, it is assumed that the specific image P, which is displayed in the area S of the image data, is generated in the odd-numbered periods T1, T3, T5, and T7. Consequently, the user who is watching the display screen (not illustrated) of the server device 200 happens to watch the specific image P in the specific area S in a flashing manner.

Firstly, at Step S3 described above, consider a case when the obtaining unit 214 receives the image data G1 that was generated in the first frame period T1. In that case; the obtaining unit 214 extracts, from the image data G1, the image portion that has got modified as compared to the default reference image and obtains the image displayed in the extracted portion as the modification image. In this example, of the image data G1, the area S represents the image portion that has got modified as compared to the default reference image. That is, there is no change in any portion other than the area S. Hence, of the image data G1, the specific area P that is displayed in the area S is obtained as the modification image. At Step S5 performed subsequently, the comparing unit 216 compares the modification image obtained at Step S4 with the specific image P stored in the specific image storing unit 215. In this case, since the modification image obtained at Step S4 completely matches with the specific image P (matches in position, size, and image portion), the screen information is not generated at Step S6 performed subsequently. Thus, no screen information is transferred, and the same image as the default reference image (i.e., the same image as the shared image V1) is displayed on the client device 300.

Then, the system control again returns to Step S3. Upon receiving the image data G2 that was generated in the second frame period T2 (Yes at Step S3), the obtaining unit 214 extracts, from the image data G2, the image portion that has got modified as compared to the previously-received image data G1 and obtains the image displayed in the extracted portion as the modification image. In this example, of the image data G2, the area S represents the image portion that has got modified as compared to the previously-received image data G1. Thus, an image Q1 displayed in the area S is obtained as the modification image. In the example illustrated in FIG. 8, the image data G2 generated in the second frame period T2 is same as the default reference image (i.e., the shared image V1) and the image Q1 that is displayed in the area S of the image data G2 is same as the image portion displayed in the area S of the default reference image. At Step S5 performed subsequently, the comparing unit 216 compares the modification image obtained at Step S4 with the specific image P. In this case, although the position and the size of the modification image obtained at Step S4 (the image Q1) matches with the position and the size of the specific image P stored in the specific image storing unit 215, the image portions thereof do not match with each other. Hence, at Step S6, the screen information generating unit 217 generates screen information that contains the image Q1 and the position information of the area S. Then, at Step S7 performed subsequently, the sending unit 218 sends the screen information, which contains the image Q1 and the position information of the area S, to the client device 300. That is, in this case, the screen information gets transferred. Thus, on the client device 300 is displayed an image in which the image portion displayed in the area S of the default reference image is modified to the image Q1. In the example illustrated in FIG. 8, since the image portion displayed in the area S of the default reference image is same as the image Q1, the image same as the default reference image (i.e., the image same as the shared image V1) is continually displayed on the client device 300.

Then, the system control again returns to Step S3. Upon receiving the image data G3 that was generated in the third frame period T3 (Yes at Step S3), the obtaining unit 214 extracts, from the image data G3, the image portion that has got modified as compared to the previously-received image data G2 and obtains the image displayed in the extracted portion as the modification image (Step S4). In the example illustrated in FIG. 8, of the image data G3, the area S represents the image portion that has got modified as compared to the previously-received image data G2, and there is no change in any portion other than the area S. Thus, the specific image P displayed in the area S is obtained as the modification image. At Step S5 performed subsequently, the comparing unit 216 compares the modification image obtained at Step S4 with the specific image P stored in the specific image storing unit 215. In this case, since the modification image obtained at Step S4 completely matches with the specific image P (matches in position, size, and image portion), the screen information is not generated at Step S6 performed subsequently. That is, no screen information is transferred, and the same image as the default reference image (i.e., the same image as the shared image V1) is continually displayed on the client device 300.

Then, the system control again returns to Step S3. Upon receiving the image data G4 that was generated in the fourth frame period T4 (Yes at Step S3), the obtaining unit 214 extracts, from the image data G4, the image portion that has got modified as compared to the previously-received image data G3 and obtains the image displayed in the extracted portion as the modification image. In the example illustrated in FIG. 8, the entire image data G4 represents the image portion that has got modified as compared to the previously-received image data G3, and an image Q2 that is same as the image data G4 (i.e., the shared image V2) is obtained as the modification image. At Step S5 performed subsequently, the comparing unit 216 compares the modification image obtained at Step S4 with the specific image P. In this case, the modification image obtained at Step S4 (i.e., the image Q2) does not match with the specific image P stored in the specific image storing unit 215. Hence, at Step S6, the screen information generating unit 217 generates screen information that contains the image Q2 and the position information of the image Q2. Then, at Step S7 performed subsequently, the sending unit 218 sends the screen information, which contains the image Q2 and the position information of the image Q2, to the client device 300. That is, in this case, the screen information gets transferred. Thus, on the client device 300, the image being displayed changes from the default reference image to the image Q2. That is, on the client device 300 is displayed the same image as the shared image V2. Besides, the newly-displayed image is registered as the new reference image in the reference image storing unit 303.

Then, the system control again returns to Step S3. Upon receiving the image data G5 that was generated in the fifth frame period T5 (Yes at Step S3), the obtaining unit 214 extracts, from the image data G5, the image portion that has got modified as compared to the previously-received image data G4 and obtains the image displayed in the extracted portion as the modification image (Step S4). In the example illustrated in FIG. 8, of the image data G5, the area S represents the image portion that has got modified as compared to the previously-obtained image data G4, and there is no change in the portion other than the area S. Thus, the specific image P displayed in the area S of the image data G5 is obtained as the modification image. At Step S5 performed subsequently, the comparing unit 216 compares the modification image obtained at Step S4 with the specific image P stored in the specific image storing unit 215. In this case, since the modification image obtained at Step S4 completely matches with the specific image P (matches in position, size, and image portion), the screen information is not generated at Step S6 performed subsequently. That is, no screen information is transferred, and the same image as the shared image V2 is continually displayed on the client device 300.

Then, the system control again returns to Step S3. Upon receiving the image data G6 that was generated in the sixth frame period T6 (Yes at Step S3), the obtaining unit 214 extracts, from the image data G6, the image portion that has got modified as compared to the previously-received image data G5 and obtains the image displayed in the extracted portion as the modification image (Step S4). In the example illustrated in FIG. 8, of the image data G6, the area S represents the image portion that has got modified as compared to the previously-obtained image data G5, and there is no change in the portion other than the area S. Thus, an image Q3 displayed in the area S of the image data G6 is obtained as the modification image. In the example illustrated in FIG. 8, since the image data G6 is same as the shared image V2, the image Q3 displayed in the area S of the image data G6 is same as the image portion displayed in the area S of the shared image V2. At Step S5 performed subsequently, the comparing unit 216 compares the modification image obtained at Step S4 with the specific image P stored in the specific image storing unit 215. In this case, although the position and the size of the modification image matches with the position and the size of the specific image P stored in the specific image storing unit 215, the image portions thereof do not match with each other. Hence, screen information containing the image Q3 and the position information of the area S is generated and transferred to the client device 300. That is, in this case, the screen information gets transferred. Thus, on the client device 300 is displayed an image in which the image portion displayed in the area S of the shared image V2 is modified to the image Q3. As described above, in the example illustrated in FIG. 8, since the image portion displayed in the area S of the shared image V2 is same as the image Q3, the image same as the shared image V2 is continually displayed on the client device 300.

Then, the system control again returns to Step S3. Upon receiving the image data G7 that was generated in the seventh frame period T7 (Yes at Step S3), the obtaining unit 214 extracts, from the image data G7, the image portion that has got modified as compared to the previously-received image data G6 and obtains the image displayed in the extracted portion as the modification image (Step S4). In the example illustrated in FIG. 8, of the image data G7, the area S represents the image portion that has got modified as compared to the previously-obtained image data G6, and there is no change in the portion other than the area S. Thus, the specific image P displayed in the area S of the image data G7 is obtained as the modification image. At Step S5 performed subsequently, the comparing unit 216 compares the modification image obtained at Step S4 with the specific image P stored in the specific image storing unit 215. In this case, since the modification image obtained at Step S4 completely matches with the specific image P (matches in position, size, and image portion), the screen information is not generated at Step S6 performed subsequently. Thus, no screen information is transferred, and the same image as the shared image V2 is continually displayed on the client device 300.

Then, the system control again returns to Step S3. Upon receiving the image data G8 that was generated in the eighth frame period T8 (Yes at Step S3), the obtaining unit 214 extracts, from the image data G8, the image portion that has got modified as compared to the previously-received image data G7 and obtains the image displayed in the extracted portion as the modification image. In the example illustrated in FIG. 8, the entire image data G8 represents the image portion that has got modified as compared to the previously-received image data G7 and an image Q4 identical to the image data G8 (i.e., the shared image V3) is obtained as the modification image. At Step S5 performed subsequently, the comparing unit 216 compares the modification image obtained at Step S4 with the specific image P. In this case, the modification image obtained at Step S4 (i.e., the image Q4) does not match with the specific image P stored in the specific image storing unit 215. Hence, at Step S6, the screen information generating unit 217 generates screen information that contains the image Q4 and the position information of the image Q4. Then, at Step S7 performed subsequently, the sending unit 218 sends the screen information, which contains the image Q4 and the position information of the image Q4, to the client device 300. That is, in this case, the screen information gets transferred. Thus, on the client device 300, the image being displayed changes from the shared image V2 to the image Q4. That is, on the client device 300 is displayed the same image as the shared image V3. Besides, the newly-displayed image Q4 is registered as the new reference image in the reference image storing unit 303.

In this way, on the client device 300, the specific image P is not displayed. Instead, background images of the specific image P (i.e., the images V1, V2, and V3) are displayed in a sequential manner.

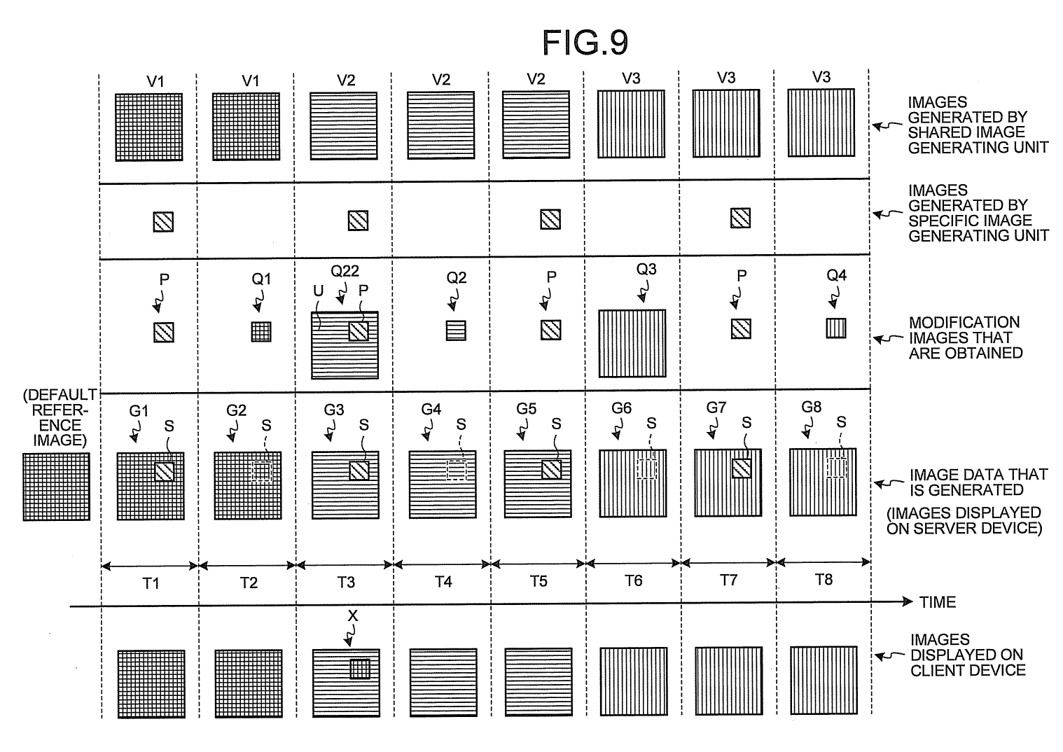

Herein, the manner in which the background images (i.e., the shared images) are modified is not restricted to any particular manner. For example, as illustrated in FIG. 9, the image V1 is generated as the shared image in the frame periods T1 and T2 (in this example, the image V1 serves as the default reference image); the image V2 is generated as the shared image in the frame periods T3 to T5; and the image V3 is generated as the shared image in the frame periods T6 to T8. In the example illustrated in FIG. 9, the specific image P, which is displayed in the area S of the image data G, is generated in the odd-numbered periods T1, T3, T5, and T7. Given below is the explanation of the example illustrated in FIG. 9.

Firstly, when the obtaining unit 214 receives the image data G1 that was generated in the first frame period T1, the specific image P displayed in the area S of the image data G1 is obtained as the modification image. Thus, the modification image completely matches with the specific image P that is stored. As a result, no screen information is transferred, and the same image as the default reference image (i.e., the same image as the shared image V1) is displayed on the client device 300.

Subsequently, when the obtaining unit 214 receives the image data G2 that was generated in the second frame period T2, the image Q1 displayed in the area S of the image data G2 is obtained as the modification image. In the example illustrated in FIG. 9, the image data G2 generated in the second frame period T2 is same as the default reference image (i.e., the shared image V1). Hence, the image Q1 that is displayed in the area S of the image data G2 is same as the image portion displayed in the area S of the shared image V1. In this case, although the position and the size of the modification image matches with the position and the size of the specific image P, the image portions thereof do not match with each other. Hence, screen information containing the image Q1 and the position of the area S is generated and transferred to the client device 300. That is, in this case, the screen information gets transferred. Thus, on the client device 300 is displayed an image in which the image portion displayed in the area S of the shared image V1 is modified to the image Q1. In other words, the same image as the shared image V1 is continually displayed.

Subsequently, upon receiving the image data G3 generated in the third frame period T3, the obtaining unit 214 extracts, from the image data G3, the image portion that has got modified as compared to the previously-received image data G2 and obtains the image displayed in the extracted portion as the modification image. In the example illustrated in FIG. 9, the entire image data G3 represents the image portion that has got modified as compared to the previously-received image data G2 and an image Q22 identical to the image data G3 is obtained as the modification image. In this case, of the modification image (i.e., the image Q22), although the image portion displayed in the area S completely matches with the specific image P, an image U displayed in the area other than the area S does not match with the specific image P. Hence, screen information containing the image U and the position information of the image U is transferred to the client device 300. Moreover, in the example illustrated in FIG. 9, the image U displayed in the area other than the area S of the image Q22 is same as the image portion displayed in the area other than the area S of the shared image V2. In this case, on the client device 300 is displayed an image X in which the image portion displayed in the area other than the area S of the shared image V2 is replaced with the image U. Besides, the image X is registered as the new reference image in the reference image storing unit 303.

Subsequently, when the obtaining unit 214 receives the image data G4 that was generated in the fourth frame period T4, the image Q2 displayed in the area S of the image data G4 is obtained as the modification image. In the example illustrated in FIG. 9, the image data G4 generated in the fourth frame period T4 is same as the shared image V2 generated in the frame periods T3 to T5. Hence, the image Q2 that is displayed in the area S of the image data G4 is same as the image portion displayed in the area S of the shared image V2. In this case, although the position and the size of the modification image matches with the position and the size of the specific image P, the image portions thereof do not match with each other. Hence, screen information containing the image Q2 and the position of the area S is generated and transferred to the client device 300. That is, in this case, the screen information gets transferred. Thus, on the client device 300 is displayed an image in which the image portion displayed in the area S of the image X is modified to the image Q2. In other words, the same image as the shared image V2 is displayed. Besides, the newly-displayed image (i.e., the same image as the shared image V2) is registered as the new reference image in the reference image storing unit 303.

Subsequently, when the obtaining unit 214 receives the image data G5 that was generated in the fifth frame period T5, the specific image P displayed in the area S of the image data G5 is obtained as the modification image. Thus, the modification image completely matches with the specific image P that is stored. As a result, no screen information is transferred, and the same image as the shared image V2 is continually displayed on the client device 300.

Subsequently, upon receiving the image data G6 that was generated in the sixth frame period T6, the obtaining unit 214 extracts, from the image data G6, the image portion that has got modified as compared to the previously-received image data G5 and obtains the image displayed in the extracted portion as the modification image. In the example illustrated in FIG. 9, the entire image data G6 represents the image portion that has got modified as compared to the previously-received image data G5 and the image Q3 identical to the image data G6 (i.e., the shared image V3) is obtained as the modification image. In this case, since the modification image (i.e., the image Q3) does not match with the specific image P, screen information containing the image Q3 and the position information of the image Q3 is sent to the client device 300. That is, in this case, the screen information gets transferred. Thus, the image displayed on the client device 300 changes from the shared image V2 to the shared image V3. Besides, the newly-displayed image (i.e., the same image as the shared image V3) is registered as the new reference image in the reference image storing unit 303.

Subsequently, when the obtaining unit 214 receives the image data G7 that was generated in the seventh frame period T7, the specific image P displayed in the area S of the image data G7 is obtained as the modification image. Thus, the modification image completely matches with the specific image P that is stored. As a result, no screen information is transferred, and the same image as the shared image V3 is continually displayed on the client device 300.

Subsequently, when the obtaining unit 214 receives the image data G8 that was generated in the eighth frame period T8, the image Q4 displayed in the area S of the image data G8 is obtained as the modification image. In the example illustrated in FIG. 9, the image data G8 generated in the eighth frame period T8 is same as the shared image V3 generated in the frame periods T6 to T8. Hence, the image Q4 that is displayed in the area S of the image data G8 is same as the image portion displayed in the area S of the shared image V3. In this case, although the position and the size of the modification image matches with the position and the size of the specific image P, the image portions thereof do not match with each other. Hence, screen information containing the image Q4 and the position of the area S is generated and transferred to the client device 300. That is, in this case, the screen information gets transferred. Thus, on the client device 300 is displayed an image in which the image portion displayed in the area S of the shared image V3 is modified to the image Q4. In other words, the same image as the shared image V3 is continually displayed. In this way, in the example illustrated in FIG. 9 too, the specific image P is not displayed on the client device 300.

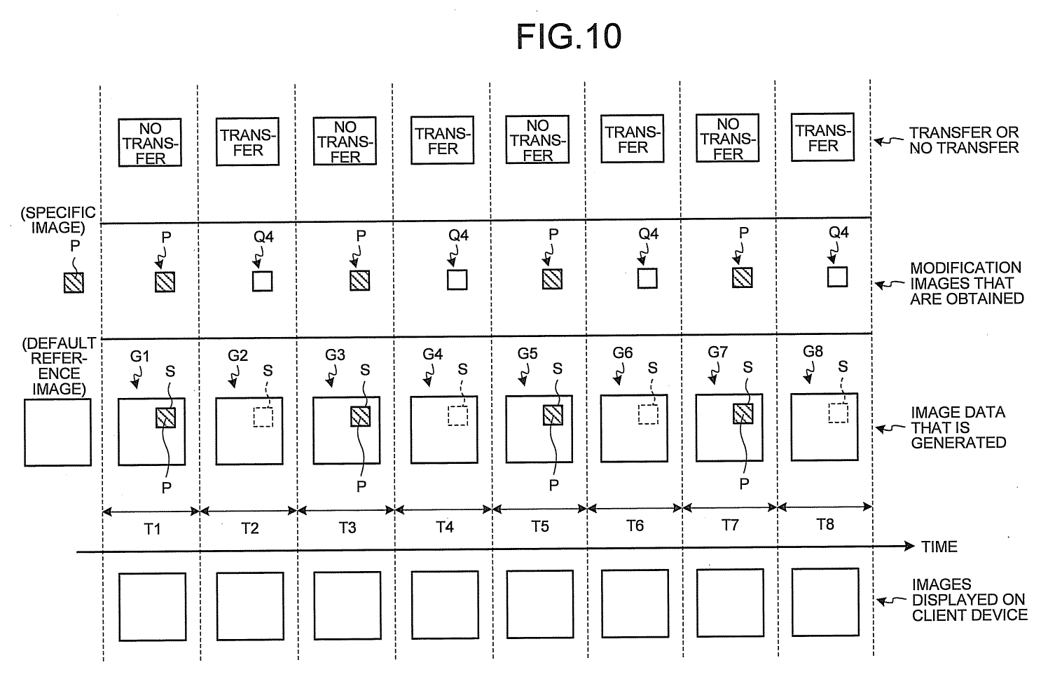

Meanwhile, as illustrated in FIG. 10 for example, the image data G generated in each of the even-numbered frame periods T2, T4, T6, and T8 can be same as the default reference image. In this case too, the operations are identical to the description given above. Thus, the specific image P is not displayed on the client device 300. Instead, the default reference image is continually displayed.

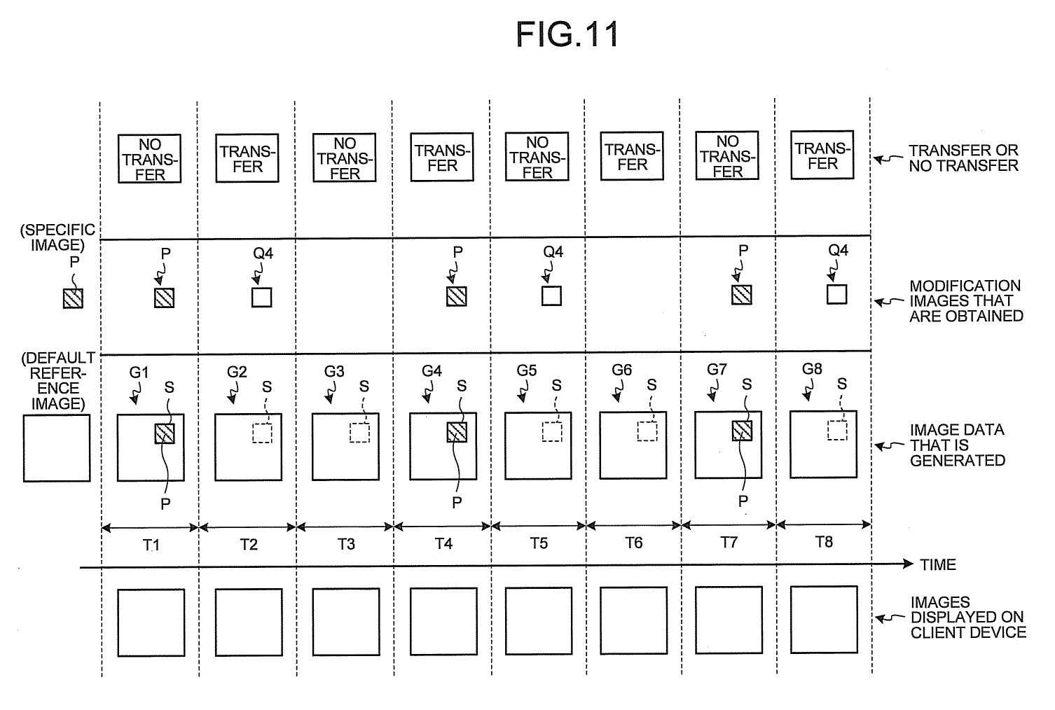

In the examples described above, an interval of a single frame period is present in between the frame periods in which the specific image P is generated (i.e., the frame periods in which the specific image P is generated are arranged alternating with the frame periods in which the specific image P is not generated). However, that is not the only possible case. That is, an interval of an arbitrary number of frames can be present in between the frame periods in which the specific image P is generated. For example, as illustrated in FIG. 11, there can be an interval of two frame periods in between the frame periods in which the specific image P is generated. In the example illustrated in FIG. 11, the specific image P is generated in each of the first frame period T1, the fourth frame period T4, and the seventh frame period T7. In the other frame periods, the specific image P is not generated and only shared images are generated. In the example illustrated in FIG. 11, in each of the frame periods T1 to T8, the same image is generated as the shared image (details not illustrated). Meanwhile, it is also possible to vary the number of frame periods in between the frame periods in which the specific image P is generated. For example, the configuration can be such that the specific image P is generated in each of the first frame period T1, the third frame period T3, and the sixth frame period T6. Thus, in the other frame periods T, the specific image P is not generated and only shared images are generated.

In the example illustrated in FIG. 11, the image data generated in the second frame period T2 points to the same image that is pointed by the image in the image data generated in the third frame period T3. Hence, when the image data generated in the third frame period T3 is received, no modification image is obtained and no screen information is transferred to the client device 300. Similarly, the image data generated in the firth frame period T5 points to the same image that is pointed by the image data generated in the sixth frame period T6. Hence, when the image data generated in the sixth frame period T6 is received, no modification image is obtained and no screen information is transferred to the client device 300. Therefore, as compared to the example illustrated in FIG. 10, the example illustrated in FIG. 11 has an advantage of a decreased amount of data transfer.

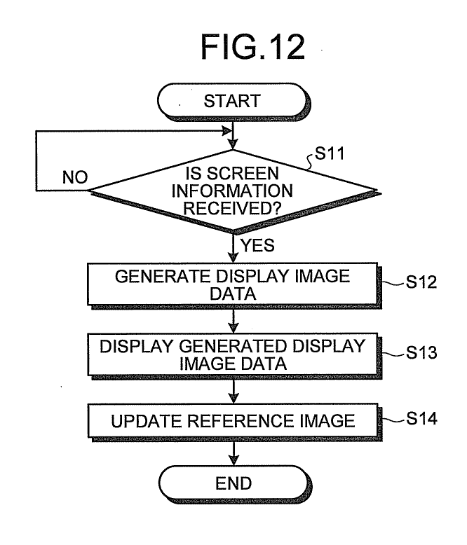

Given below is the explanation of exemplary operations performed by the client device 300. In the first embodiment, the client device 300 generates the display image data by referring to the screen information received from the server device 200 and then performs a display operation for displaying the display image data on a display screen. FIG. 12 is a flowchart for explaining an exemplary sequence in the display operation performed by the client device 300. Thus, the display operation is explained below with reference to FIG. 12.

As illustrated in FIG. 12, when the receiving unit 301 receives screen information from the server device 200 (Yes at Step S11), the display control unit 304 refers to the screen information as well as to the reference image stored in the reference image storing unit 303, and accordingly generates display image data (Step S12). Then, the display control unit 304 displays the generated display image data on the display screen (not illustrated) of the client device 300 (Step S13). Subsequently, the updating unit 305 updates the reference image, which is stored in the reference image storing unit 303, to the display image data generated at Step S12 (Step S14). In the client device 300, such sequence in the display operation is performed in a repeated manner.

### Advantageous Effect

As described above, in the first embodiment, of the modification images, the image portions matching with the specific images are not sent to the client device 300 by the server device 200. Thus, a plurality of pieces of image data is generated in a sequential manner in such a way that the images not to be displayed on the client device 300 (i.e., the specific images) are included in the modification images. With that, without displaying the specific image P on the client device 300, the images before getting modified to the specific image P can be displayed on the client device 300. According to the first embodiment, the server device 200 need not generate the image data to be displayed on the display screen thereof separately from the image data to be sent to the client device 300, and need not have separate frame buffers. That enables achieving simplification in the configuration thereby leading to a reduction in the manufacturing cost.

### B: Second Embodiment

Given below is the explanation of a second embodiment. With respect to the first embodiment, the second embodiment differs in the point that the client device 300 obtains a modification image and performs display control according to the comparison result of the modification image and the specific image. In the second embodiment, the constituent elements identical to those explained in the first embodiment are referred to by the same reference numerals, and the explanation thereof is not repeated.

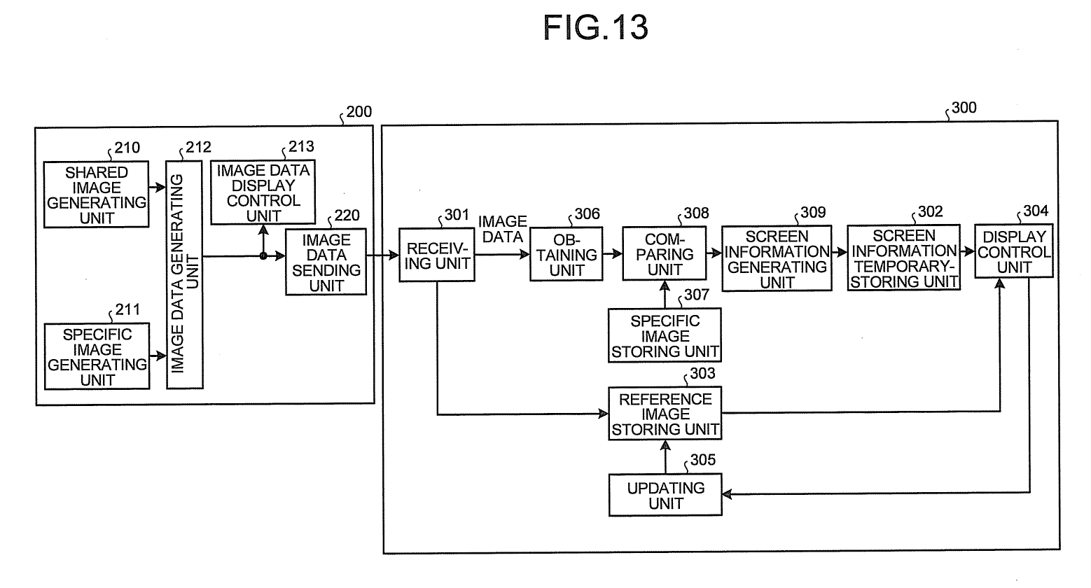

FIG. 13 is a block diagram of an exemplary functional configuration of the server device 200 and the client device 300 according to the second embodiment. As illustrated in FIG. 13, the functions of the server device 200 include the shared image generating unit 210, the specific image generating unit 211, the image data generating unit 212, the image data display control unit 213, and an image data sending unit 220. Herein, since the shared image generating unit 210, the specific image generating unit 211, the image data generating unit 212, and the image data display control unit 213 are identical to the first embodiment; the detailed explanation thereof is not repeated. The image data sending unit 220 sends the image data, which is generated by the image data generating unit 212, to the client device 300. Moreover, the image data sending unit 220 obtains a default reference image from the image data generating unit 212 and sends that default reference image in advance to the client device 300.

As illustrated in FIG. 13, the functions of the client device 300 include the receiving unit 301, the screen information temporary-storing unit 302, the reference image storing unit 303, the display control unit 304, the updating unit 305, an obtaining unit 306, a specific image storing unit 307, a comparing unit 308, and a screen information generating unit 309. The receiving unit 301 receives image data and the reference image that have been transferred from the server device 200. The obtaining unit 306 has the function of obtaining modification images, which is identical to the function of the obtaining unit 214 illustrated in FIG. 3. More particularly, every time the receiving unit 301 receives image data, the obtaining unit 306 obtains a modification image representing an image portion that has got modified as compared to the corresponding previous piece of image data from among the received pieces of image data. The specific image storing unit 307 has the function of storing a specific image, which is identical to the function of the specific image storing unit 215 illustrated in FIG. 3.

The comparing unit 308 has the same function as that of the comparing unit 216 illustrated in FIG. 3. That is, the comparing unit 308 compares a modification image obtained by the obtaining unit 306 with the specific image stored in the specific image storing unit 307. The screen information generating unit 309 has the same function as that of the screen information generating unit 217 illustrated in FIG. 3. That is, the screen information generating unit 217 refers to the comparison result obtained by the comparing unit 308 and generates screen information, which contains the image portion of the modification image that does not match with the specific image and which contains position information of the image portion. Then, the screen information generating unit 309 sends the screen information to the screen information temporary-storing unit 302. Herein, since the screen information temporary-storing unit 302, the reference image storing unit 303, the display control unit 304, and the updating unit 305 are identical to the first embodiment, the detailed explanation thereof is not repeated.

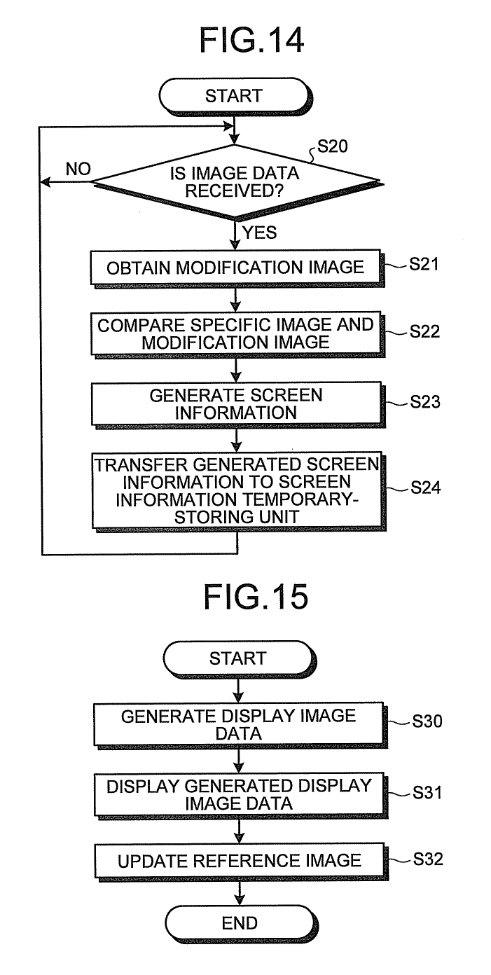

In the second embodiment, the client device 300 obtains a modification image on the basis of the image data sent by the server device 200 and performs a screen information transfer operation for transferring the screen information, which contains the image portion of the modification image that does not match with the specific image and which contains position information of the image portion, to the screen information temporary-storing unit 302. FIG. 14 is a flowchart for explaining an exemplary sequence in a screen information generation operation performed by the client device 300 according to the second embodiment. Thus, the following explanation regarding the screen information generation operation is given with reference to FIG. 14.

As illustrated in FIG. 14, when the receiving unit 301 receives the image data from the server device 200 (Yes at Step S20), the obtaining unit 306 extracts, from the received piece of image data, the portion (area) that has got modified as compared to the corresponding previous piece of image data and obtains the image displayed in the extracted portion as the modification image (Step S21). The details of this operation are identical to Step S4 explained with reference to FIG. 7. Then, the comparing unit 308 compares the modification image obtained at Step S21 with the specific image stored in the specific image storing unit 307 (Step S22). The details of this operation are identical to Step S5 explained with reference to FIG. 7.

Subsequently, the screen information generating unit 309 refers to the comparison result obtained at Step S22 and accordingly generates screen information (Step S23). The details of this operation are identical to Step S6 explained with reference to FIG. 7. Then, the screen information generating unit 309 transfers the screen information generated at Step S23 to the screen information temporary-storing unit 302 (Step S24). If no screen information is generated at Step S23, then no screen information is transferred to the screen information temporary-storing unit 302. Then, the system control returns to Step S20.

Moreover, in the second embodiment, the client device 300 generates display image data by referring to the screen information stored in the screen information temporary-storing unit 302 and to the reference image stored in the reference image storing unit 303, and then performs a display operation for displaying the display image data on a display screen. FIG. 15 is a flowchart for explaining an exemplary sequence in the display operation performed by the client device 300 according to the second embodiment. Thus, the display operation is explained below with reference to FIG. 15.

As illustrated in FIG. 15, the display control unit 304 refers to the screen information stored in the screen information temporary-storing unit 302 and to the reference image stored in the reference image storing unit 303, and generates display image data that represents the image data to be displayed and that does not include the image portion of the modification image which matches with the specific image (Step S30). Then, the display control unit 304 displays the display image data on the display screen (not illustrated) of the client device (Step S31). Subsequently, the updating unit 305 updates the reference image, which is stored in the reference image storing unit 303, to the display image data that was generated at Step S30 (Step S32). In the client device 300, such sequence in the display operation is performed in a repeated manner.

With such a configuration too, in an identical manner to the first embodiment, the server device 200 need not generate the image data to be displayed on the display screen thereof separately from the image data to be sent to the client device 300, and need not have separate frame buffers. That enables achieving simplification in the configuration thereby leading to a reduction in the manufacturing cost.

### C: Third Embodiment

Given below is the explanation of a third embodiment. With respect to the abovementioned embodiments, the screen transfer system according to the third embodiment differs in the point that a relay device 400 is additionally installed to communicate with each of the server device 200 and the client device 300. The relay device 400 obtains a modification image on the basis of a plurality of pieces of image data generated in a sequential manner by the server device 200, generates screen information, which contains the image portion of the modification image that does not match with the specific image and which contains position information of that image portion, and sends the screen information to the client device 300. In the third embodiment, the constituent elements identical to those explained in the abovementioned embodiments are referred to by the same reference numerals, and the explanation thereof is not repeated.

In the third embodiment, as the screen sending function of the server device 200, a screen sending method (a screen transfer method) using a pull-type screen transfer protocol is implemented. For example, in a screen sending method known as virtual network computing (VNC); when the receiving side (herein, the relay device 400) sends a screen obtaining request called a framebuffer update request to the sending side (herein, the server device 200), the sending side sends a screen to the receiving side as a response called a framebuffer update. Meanwhile, in the third embodiment, as the screen sending function of the relay device 400, a push-type screen transfer protocol is used for performing screen transfer. In the push-type screen transfer protocol, the sending side (herein, the relay device 400) sends a screen to the receiving side (herein, the client device 300) without waiting for the receipt of a screen obtaining request from the receiving side.

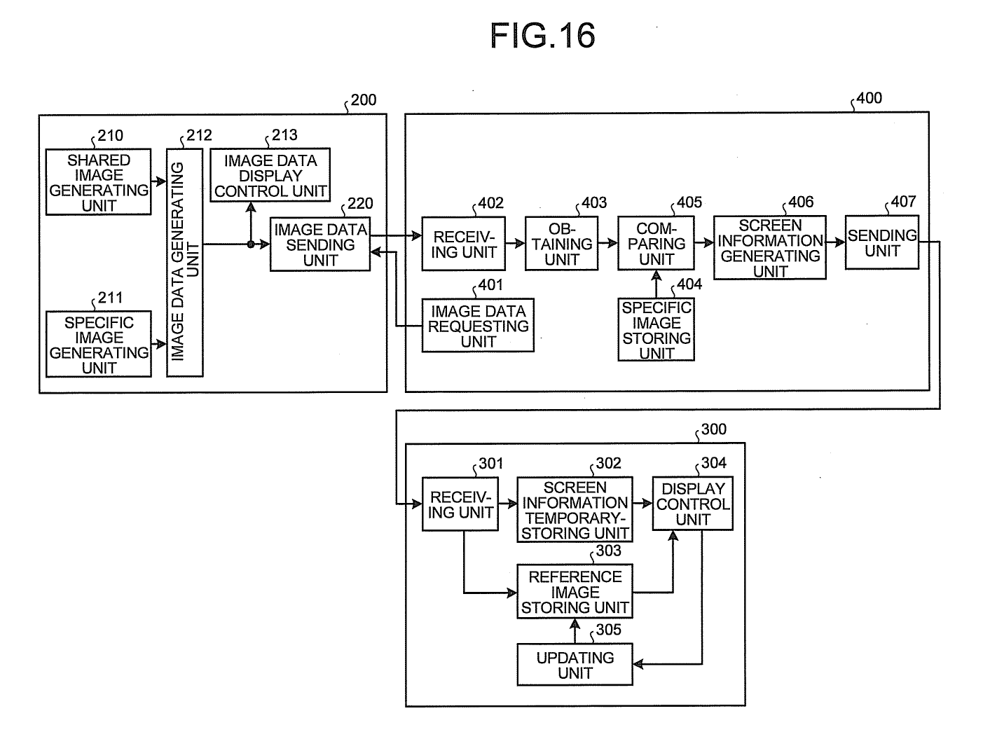

FIG. 16 is a block diagram of an exemplary functional configuration of the server device 200, the client device 300, and the relay device 400 according to the third embodiment. Since the basic hardware configuration of the relay device 400 is identical to the hardware configuration of the server device 200 (see FIG. 2), the detailed explanation thereof is also not repeated. Moreover, since the functional configuration of the server device 200 is identical to that described in the second embodiment, the detailed explanation thereof is not repeated. Furthermore, since the functional configuration of the client device 300 is identical to that described in the first embodiment, the detailed explanation thereof is also not repeated.

As illustrated in FIG. 16, the functions of the relay device 400 include an image data requesting unit 401, a receiving unit 402, an obtaining unit 403, a specific image storing unit 404, a comparing unit 405, a screen information generating unit 406, and a sending unit 407. The image data requesting unit 401 sends, to the server device 200, a request signal as a request to send image data. Upon sending a request signal for the first time, the image data requesting unit 401 can send the request signals at predetermined periods. Alternatively, every time image data is received from the server device 200, the image data requesting unit 401 can send the next request signal. The receiving unit 402 receives the image data and the reference image that is transferred by the server device 200. The obtaining unit 403 has the function of obtaining modification images, which is identical to the function of the obtaining unit 214 illustrated in FIG. 3. More particularly, every time the receiving unit 402 receives image data, the obtaining unit 403 obtains a modification image representing an image portion that has got modified as compared to the corresponding previous piece of image data from among the received pieces of image data. The specific image storing unit 404 has the function of storing a specific image, which is identical to the function of the specific image storing unit 215 illustrated in FIG. 3.

The comparing unit 405 has the same function as that of the comparing unit 216 illustrated in FIG. 3. That is, the comparing unit 405 compares a modification image obtained by the obtaining unit 403 with the specific image stored in the specific image storing unit 404. The screen information generating unit 406 has the same function as that of the screen information generating unit 217 illustrated in FIG. 3. That is, the screen information generating unit 406 refers to the comparison result obtained by the comparing unit 405 and generates screen information, which contains the image portion of the modification image obtained by the obtaining unit 403 that does not match with the specific image and which contains position information of that image portion. The sending unit 407 has the same function as that of the sending unit 218 illustrated in FIG. 3. That is, the sending unit 407 sends the screen information generated by the screen information generating unit 406 to the client device 300. Moreover, the sending unit 407 sends in advance the default reference image, which is received from the server device 200, to the client device 300.

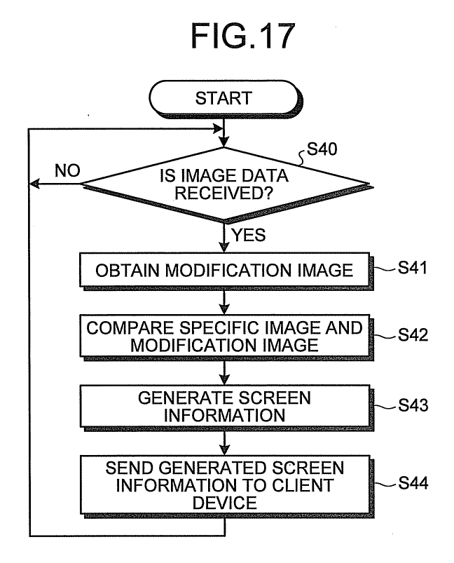

In the third embodiment, the relay device 400 performs a screen information transfer operation for transferring the generated screen information to the client device 300. FIG. 17 is a flowchart for explaining an exemplary sequence in the screen information transfer operation performed by the relay device 400. Thus, the following explanation regarding the screen information transfer operation is given with reference to FIG. 17.

As illustrated in FIG. 17, when the receiving unit 402 receives image data from the server device 200 (Yes at Step S40), the obtaining unit 403 extracts, from the received set of image data, the portion (area) that has got modified as compared to the corresponding previous piece of image data and obtains the image displayed in the extracted portion as the modification image (Step S41). The details of this operation are identical to Step S4 explained with reference to FIG. 7. Then, the comparing unit 405 compares the modification image obtained at Step S41 with the specific image stored in the specific image storing unit 404 (Step S42). The details of this operation are identical to Step S5 explained with reference to FIG. 7.

Subsequently, the screen information generating unit 406 refers to the comparison result obtained at Step S42 and accordingly generates screen information (Step S43). The details of this operation are identical to Step S6 explained with reference to FIG. 7. Then, the screen information generating unit 406 transfers the screen information generated at Step S43 to the client device 300 (Step S44). If no screen information is generated at Step S43, then no screen information is transferred to the client device 300. The details of this operation are identical to Step S7 explained with reference to FIG. 7. Then, the system control returns to Step S40.

With such a configuration too, in an identical manner to the embodiments described above, the server device 200 need not generate the image data to be displayed on the display screen thereof separately from the image data to be sent to the client device 300, and need not have separate frame buffers. That enables achieving simplification in the configuration thereby leading to a reduction in the manufacturing cost.

### D: Modification Examples

Explained below are modification examples, of which two or more modification examples can be combined in an arbitrary manner.

### (1) First Modification Example

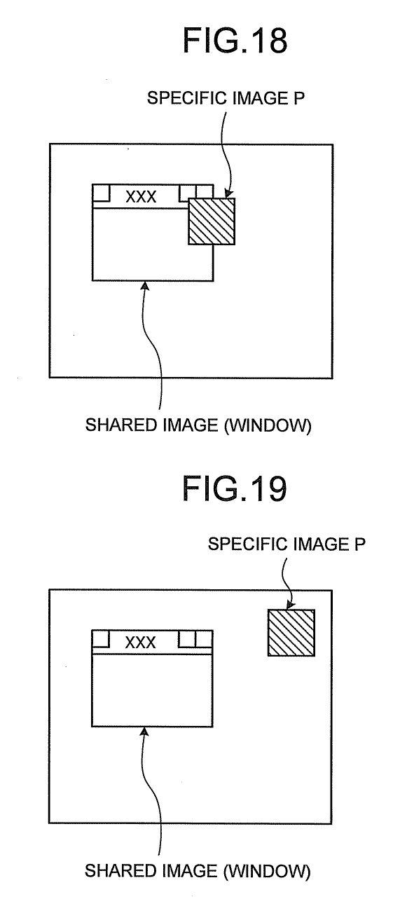

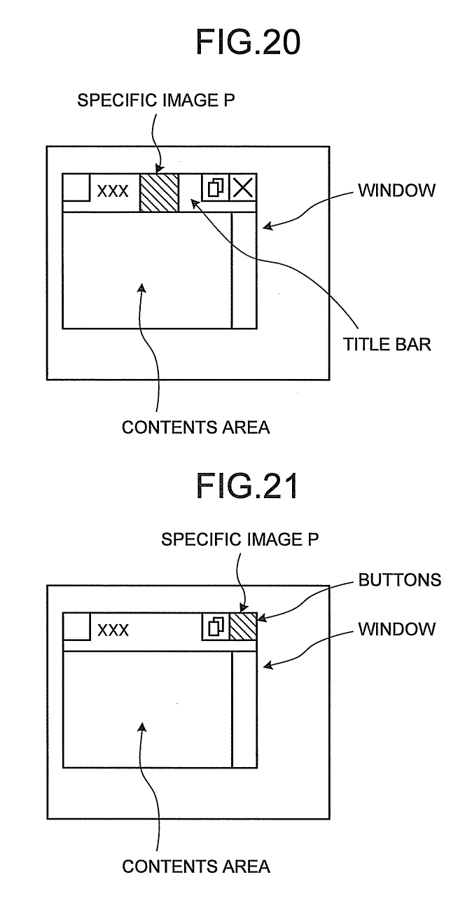

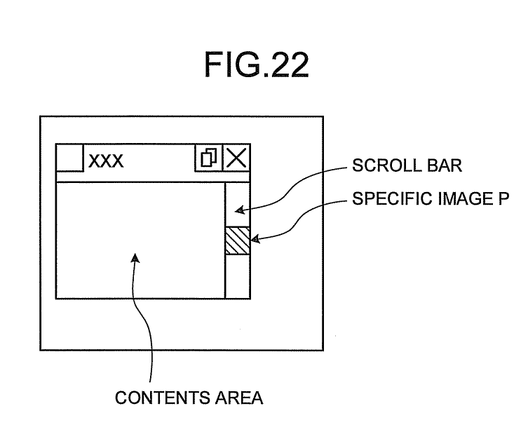

In the first embodiment described above, in the image data generated by the image data generating unit 212, the area S serves as the display position of the specific image P. However, alternatively, the display position of the specific position P can be changed in an arbitrary manner. For example, as illustrated in FIG. 18, the specific image P can be displayed in an overlapping manner on the window of the shared image. Alternatively, for example, as illustrated in FIG. 19, the specific image P can be displayed while avoiding the area in which the window of the shared image is displayed. Still alternatively, the specific image P can be displayed in an area other than a contents area, in which the contents are displayed, of the window of the shared image. For example, as illustrated in FIG. 20, the specific image P can be displayed inside an area of the window in which a title bar is displayed. Alternatively, as illustrated in FIG. 21, the specific image P can be displayed in an area of the window in which buttons are displayed. Still alternatively, as illustrated in FIG. 22, the specific image P can be displayed inside an area in the window in which a scroll bar is displayed.

### (2) Second Modification Example

In the first embodiment described above, the image data generating unit 212 generates a plurality of pieces of image data in a sequential manner in such a way that the specific image is displayed in the area S in a flashing manner. However, alternatively, the image data generating unit 212 can generate a plurality of pieces of image data in a sequential manner in such a way that the display position of the specific image changes over time. In essence, the plurality of pieces of image data can be generated in any way as long as the image (the specific image) not to be displayed on the client device 300 is included in the modification images. Consider the case of generating a plurality of pieces of image data in such a way that the display position of the specific image P changes over time. In that case, although the details of the screen information transfer operation performed by the server device 200 are substantially identical to the details described with reference to FIG. 7; the specification information is not stored in the specific image storing unit 215, and the comparing unit 216 compares the modification image obtained by the obtaining unit 214 with the specific image stored in the specific image storing unit 215 without taking into account the display position of the modification image (i.e., the comparing unit 216 compares only images).

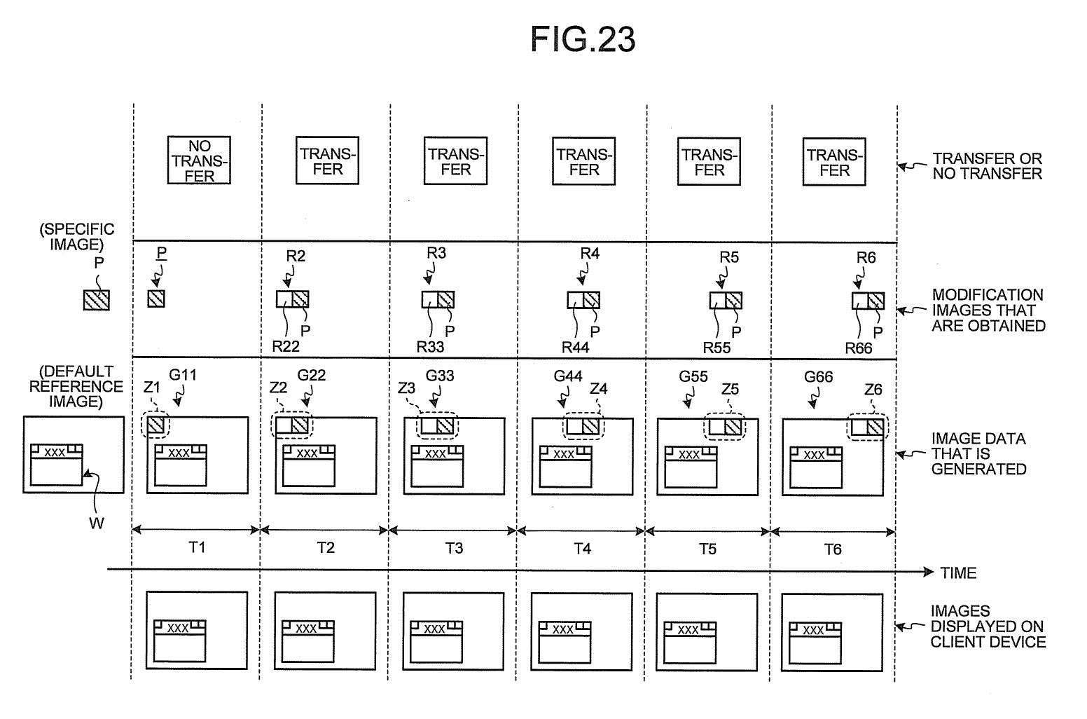

Herein, as illustrated in FIG. 23, assume that the image data generating unit 212 sequentially generates six pieces of image data G11 to G66 in such a way that the display position of the specific image P changes over time. The period for which the six pieces of image data G11 to G66 are generated includes six frame periods T1 to T6. In the example illustrated in FIG. 23, in the pieces of image data G generated in the time periods T, the areas in which the specific image P is displayed are mutually different without overlapping on each other. Moreover, in each piece of image data G, a window W is displayed in a predetermined area as an example of the shared image. The default reference image prior to starting the display of the specific image P has only the window W displayed therein. When the plurality of pieces of image data is sequentially generated and displayed on the display screen (not illustrated) of the server device 200 as illustrated in FIG. 23, the user who is watching the display screen sees the display position of the specific image P moving in the horizontal direction as time advances.

Explained below with reference to the flowchart illustrated in FIG. 7 and with reference to FIG. 23 are the specific details of the screen information transfer operation performed in the case when the image data generating unit 212 sequentially generates the six pieces of image data G11 to G66 illustrated in FIG. 23. Firstly, assume that, at Step S3 illustrated in FIG. 7, the obtaining unit 214 obtains the image data G11 that was generated in the first frame period T1. In that case, at Step S4 performed subsequently, the obtaining unit 214 extracts, from the received piece of image data G11, the image portion that has got modified as compared to the default reference image and obtains the image displayed in the extracted portion as the modification image. In the example illustrated in FIG. 23, of the image data G11, the image portion that has got modified as compared to the default reference image points to an area Z1, while the portion other than the area Z1 remains unchanged. Hence, of the image data G11, the specific image P displayed in the area Z1 is obtained as the modification image. At Step S5 performed subsequently, the comparing unit 216 compares the modification image obtained at Step S4 with the specific image P stored in the specific image storing unit 215. In this case, since the modification image obtained at Step S4 is the specific image P (i.e., since the modification image matches with the specific image P), the screen information is not generated at Step S6 performed subsequently. Thus, no screen information is transferred, and the default reference image is displayed on the client device 300.

Then, the system control again returns to Step S3. Upon receiving the image data G22 that was generated in the second frame period T2 (Yes at Step S3), the obtaining unit 214 extracts, from the image data G22, the image portion that has got modified as compared to the previously-received image data G11 and obtains the image displayed in the extracted portion as the modification image. In the example illustrated in FIG. 23, of the image data G22, an image R2 displayed in an area Z2 is obtained as the modification image. At Step S5 performed subsequently, the comparing unit 216 compares the modification image obtained at Step S4 with the specific image P. In this case, only a portion of the modification image (i.e., the image R2) obtained at Step S4 matches with the specific image P, and an image R22 in the remaining portion does not match with the specific image P. Hence, at Step S6 performed subsequently, the screen information generating unit 217 generates screen information containing the image R22 and the position information of the image R22. At Step S7 performed subsequently, the sending unit 218 sends the screen information, which contains the image R22 and the position information of the image R22, to the client device 300. However, in the example illustrated in FIG. 23, of the reference image (i.e., the default reference image) stored in the reference image storing unit 303 of the client device 300, the image portion displayed in the area that is indicated by the position information of the image R22 is same as the image R22. Therefore, the default reference image is continually displayed on the client device 300.

Then, the system control again returns to Step S3. Upon receiving the image data G33 that was generated in the third frame period T3 (Yes at Step S3), the obtaining unit 214 extracts, from the image data G33, the image portion that has got modified as compared to the previously-received image data G22 and obtains the image displayed in the extracted portion as the modification image. In the example illustrated in FIG. 23, of the image data G33, an image R3 displayed in an area Z3 is obtained as the modification image. At Step S5 performed subsequently, the comparing unit 216 compares the modification image obtained at Step S4 with the specific image P. In this case, only a portion of the modification image (i.e., the image R3) obtained at Step S4 matches with the specific image P, and an image R33 in the remaining portion does not match with the specific image P. Hence, at Step S6 performed subsequently, the screen information generating unit 217 generates screen information containing the image R33 and the position information of the image R33. At Step S7 performed subsequently, the sending unit 218 sends the screen information, which contains the image R33 and the position information of the image R33, to the client device 300. However, in the example illustrated in FIG. 23, of the default reference image, the image portion displayed in the area that is indicated by the position information of the image R33 is same as the image R33. Therefore, the default reference image is continually displayed on the client device 300.

Then, the system control again returns to Step S3. Upon receiving the image data G44 that was generated in the fourth frame period T4 (Yes at Step S3), the obtaining unit 214 extracts, from the image data G44, the image portion that has got modified as compared to the previously-received image data G33 and obtains the image displayed in the extracted portion as the modification image. In the example illustrated in FIG. 23, of the image data G44, an image R4 displayed in an area Z4 is obtained as the modification image. At Step S5 performed subsequently, the comparing unit 216 compares the modification image obtained at Step S4 with the specific image P. In this case, only a portion of the modification image (i.e., the image R4) obtained at Step S4 matches with the specific image P, and an image R44 in the remaining portion does not match with the specific image P. Hence, at Step S6 performed subsequently, the screen information generating unit 217 generates screen information containing the image R44 and the position information of the image R44. At Step S7 performed subsequently, the sending unit 218 sends the screen information, which contains the image R44 and the position information of the image R44, to the client device 300. However, in the example illustrated in FIG. 23, of the default reference image, the image portion displayed in the area that is indicated by the position information of the image R44 is same as the image R44. Therefore, the default reference image is continually displayed on the client device 300.

Then, the system control again returns to Step S3. Upon receiving the image data G55 that was generated in the fifth frame period T5 (Yes at Step S3), the obtaining unit 214 extracts, from the image data G55, the image portion that has got modified as compared to the previously-received image data G44 and obtains the image displayed in the extracted portion as the modification image. In the example illustrated in FIG. 23, of the image data G55, an image R5 displayed in an area Z5 is obtained as the modification image. At Step S5 performed subsequently, the comparing unit 216 compares the modification image obtained at Step S4 with the specific image P. In this case, only a portion of the modification image (i.e., the image R5) obtained at Step S4 matches with the specific image P, and an image R55 in the remaining portion does not match with the specific image P. Hence, at Step S6 performed subsequently, the screen information generating unit 217 generates screen information containing the image R55 and the position information of the image R55. At Step S7 performed subsequently, the sending unit 218 sends the screen information, which contains the image R55 and the position information of the image R55, to the client device 300. However, in the example illustrated in FIG. 23, of the default reference image, the image portion displayed in the area that is indicated by the position information of the image R55 is same as the image R55. Therefore, the default reference image is continually displayed on the client device 300.

Then, the system control again returns to Step S3. Upon receiving the image data G66 that was generated in the sixth frame period T6 (Yes at Step S3), the obtaining unit 214 extracts, from the image data G66, the image portion that has got modified as compared to the previously-received image data G55 and obtains the image displayed in the extracted portion as the modification image. In the example illustrated in FIG. 23, of the image data G66, an image R6 displayed in an area Z6 is obtained as the modification image. At Step S5 performed subsequently, the comparing unit 216 compares the modification image obtained at Step S4 with the specific image P. In this case, only a portion of the modification image (i.e., the image R6) obtained at Step S4 matches with the specific image P, and an image R66 in the remaining portion does not match with the specific image P. Hence, at Step S6 performed subsequently, the screen information generating unit 217 generates screen information containing the image R66 and the position information of the image R66. At Step S7 performed subsequently, the sending unit 218 sends the screen information, which contains the image R66 and the position information of the image R66, to the client device 300. However, in the example illustrated in FIG. 23, of the default reference image, the image portion displayed in the area that is indicated by the position information of the image R66 is same as the image R66. Therefore, the default reference image is continually displayed on the client device 300.

Herein, the explanation is given for a case in which the image portion that does not match with the specific image P in the modification image does not get modified as compared to the default reference image. However, that is not the only possible case. Alternatively, the image portion that does not match with the specific image P may also change from the default reference image as time advances. In that case, the temporal changes in the image portion that does not match with the specific image P are displayed on the client device 300.

In the abovementioned example too, the server device 200 sequentially generates a plurality of pieces of image data in such a way that the image not to be displayed on the client device 300 (i.e., the specific image) is included in the modification images. With that, without displaying the specific image P on the client device 300, the images before getting modified to the specific image P can be displayed on the client device 300. Moreover, in an identical manner to the first embodiment, the server device 200 need not generate the image data to be displayed on the display screen thereof separately from the image data to be sent to the client device 300, and need not have separate frame buffers. That enables achieving simplification in the configuration thereby leading to a reduction in the manufacturing cost.

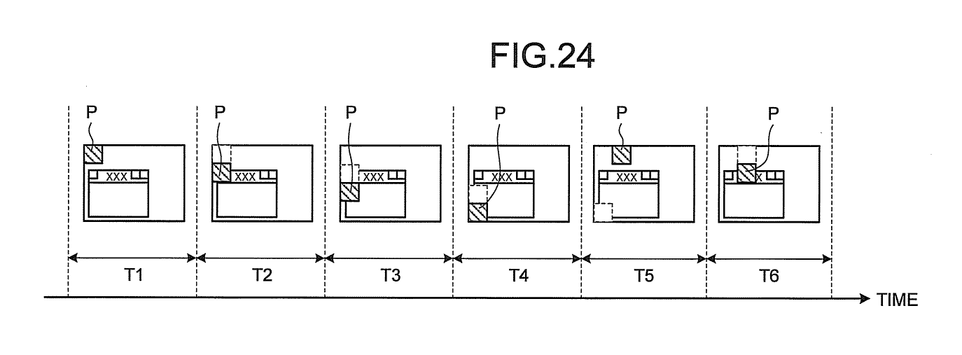

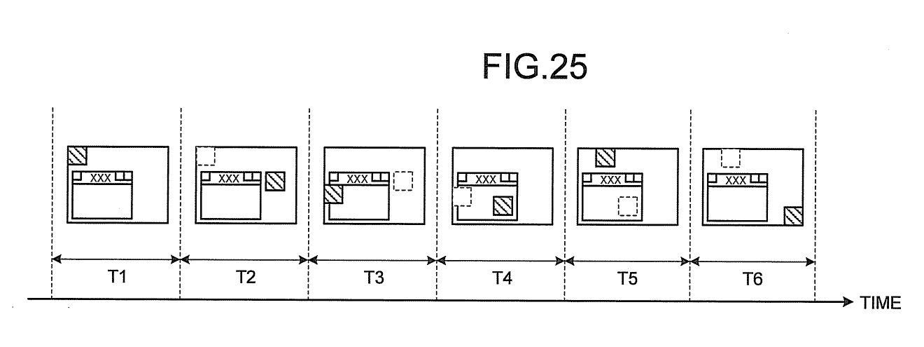

Moreover, in the abovementioned example, the image data generating unit 212 sequentially generates a plurality of pieces of image data in such a way that the display position of the specific image P moves in the horizontal direction as time advances. However, that is not the only possible case. For example, as illustrated in FIG. 24, the image data generating unit 212 can sequentially generate a plurality of pieces of image data in such a way that the display position of the specific image P moves in the vertical direction as time advances. In the example illustrated in FIG. 24, the display position of the specific image P moves downward from the uppermost level at the left side of the screen and, upon reaching the lowermost level, moves downward from the uppermost level of the next line. Still alternatively, as illustrated in FIG. 25, the image data generating unit 212 can generate a plurality of pieces of image data in such a way that the display position of the specific image P changes in a random manner as time advances. In essence, as long as the image data generating unit 212 generates a plurality of pieces of image data in such a way that the display position of the specific image P changes with time, the regularity of changes is not restricted to any particular manner. Meanwhile, the explanation given above is given with reference to the modifications of the first embodiment. However, the same modifications are also applicable to the second embodiment and to the third embodiment.

### (3) Third Modification Example

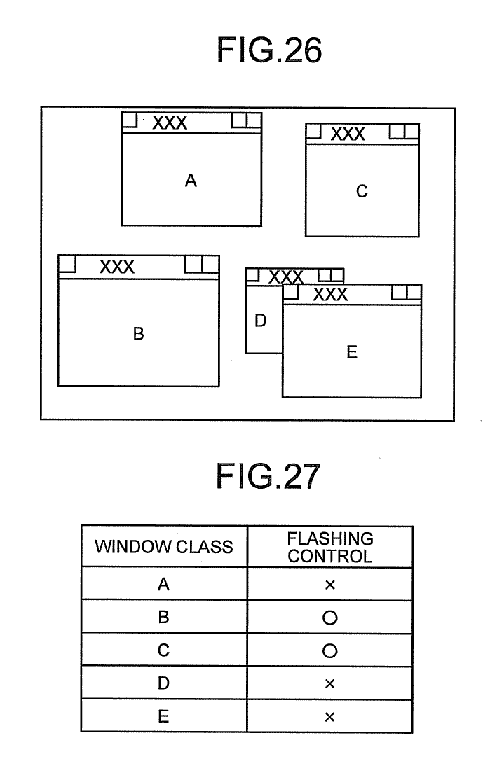

Herein, any method can be implemented to generate the specific image. The following explanation is given with reference to an example of generating image data as illustrated in FIG. 26. The image data illustrated in FIG. 26 contains a window A identified by a window class name “A”, a window B identified by a window class name “B”, a window C identified by a window class name “C”, a window D identified by a window class name “D”, and a window E identified by a window class name “E”.

As an example, the specific image generating unit 211 can generate the specific image while referring to a data table illustrated in FIG. 27. In the data table, the window class names are stored in a corresponding manner with flashing control information that indicates whether or not to perform flashing control of each window identified by a window class name. The data table is stored in a memory device (not illustrated). However, the type of the memory device storing the data table as well as the storage location of the data table is arbitrary. Thus, the memory device storing the data table can be installed in the server device 200 or can be installed in the client device 300 or in another external device.

In the example illustrated in FIG. 27, flashing control has been specified for the window B identified by the window class name “B” and for the window C identified by the window class name “C”. In other words, it can be said that, on the one hand, the windows B and C are specified as specific images that are not to be displayed on the client device 300; and, on the other hand, the windows A, D, and E are specified as shared images. When a command that instructs generation of image data is input, the specific image generating unit 211 refers to the data table illustrated in FIG. 27; generates the windows B and C, which are specified as specific images (i.e., specified to be subjected to flashing control), at predetermined timings (such as at each odd-numbered frame period); and sends the windows B and C to the image data generating unit 212. On the other hand, the shared image generating unit 210 refers to the data table illustrated in FIG. 27; generates, at each frame period, the windows A, D, and E that are specified as shared images (i.e., specified to not to be subjected to flashing control); and sends the windows A, D, and E to the image data generating unit 212.

Herein, as an example, it is explained that the window class names are stored in the data table in a corresponding manner with the flashing control information. However, that is not the only possible case. Alternatively, for example, in the data table, each window class name can be stored in a corresponding manner with information that specifies whether or not to perform control for changing with time the display position of the window identified by that window class name.

### (4) Fourth Modification Example

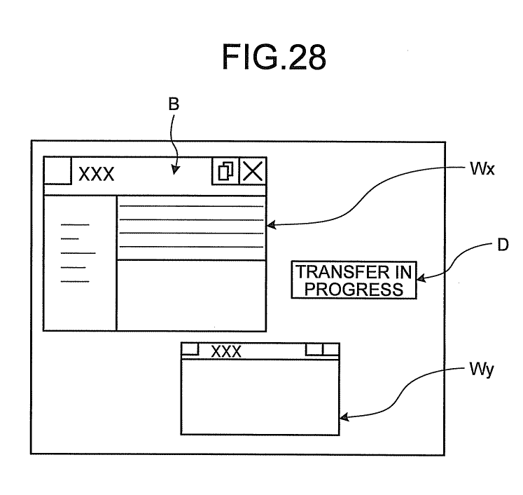

Herein, the types of specific images or the number of specific images is arbitrary. For example, the window of a mail application or a warning dialog can also be used as a specific image. Although the following explanation of a specific example is given with reference to the first embodiment, the same explanation is also applicable to the second and third embodiments. FIG. 28 is a diagram illustrating an exemplary screen on the screen device 200. In that exemplary screen, it is assumed that a window Wx of a mail application containing privacy information is displayed in the top left region, a warning dialog D for issuing a warning that the screen transfer operation is in progress is displayed in the right side, and a window Wy of a shared image is displayed at the bottom of the center. For example, in the warning display D; a string “transfer in progress” is displayed indicating that the image information is currently being transferred to the client device 300.

It makes sense that the dialog D is displayed on the server device 200, and there is no need to display it on the client device 300. Moreover, it is not desirable that the window Wx containing privacy information is displayed on the client device 300. Hence, in this example, the dialog D and the window Wx are stored as specific images in the specific image storing unit 215. Furthermore, in this example, a plurality of pieces of image data is generated in such a way that the dialog D and the window Wx are displayed in a flashing manner. As described above, the specific image generating unit 211 can generate the specific images while referring to the data table in which the window class names are stored in a corresponding manner with the flashing control information. Meanwhile, it is possible to arbitrarily change colors of the specific images that are displayed in a flashing manner on the display screen of the server device 200. For example, a title bar portion B of the window Wx can be changed from the usual “blue” to “yellow”. That is done for the following reason. The title bar of any window usually has the same color. However, if the usual color is not changed; then, while comparing a few pixels of the title bars, an unintended window may also get determined to be a specific image. Thus, by changing the usual color, a specific image can be determined by means of color comparison.

As described in the first embodiment, of the modification image that is obtained, the portion matching with the specific image is not sent to the client device 300 by the server device 200. Hence, if a plurality of pieces of image data is generated in a sequential manner in such a way that the dialog D and the window Wx are included in the modification images, it becomes possible to not display the dialog D and the window Wx on the client device 300.

Meanwhile, in the examples and embodiments described above, the configuration can be such that, when only a portion of the obtained modification image matches with the specific image, the entire modification image is not sent to the client device 300. The following explanation is given for a case when the title bar portion B of the window Wx is stored as a specific image in the specific image storing unit 215. In this example, in the specific image storing unit 215 is also stored specification information that specifies the display position of the title bar portion B.

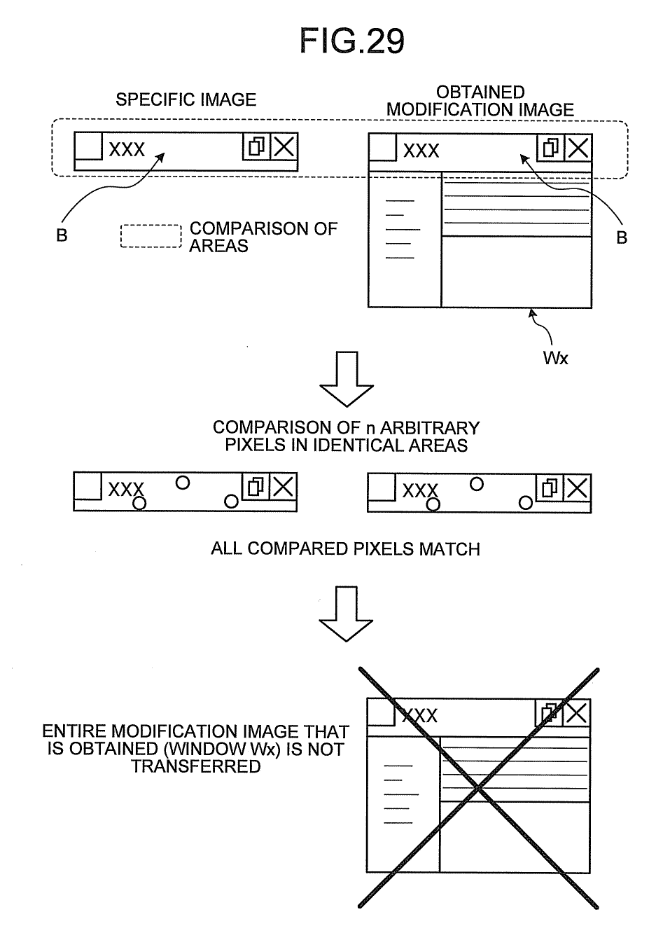

As illustrated in FIG. 29, when the entire window Wx is obtained as the modification image, the comparing unit 216 compares the specific image with the image portion in the modification image which is displayed at the position specified in the specification information (i.e., in the area corresponding to the display position of the title bar portion B). Although the method of comparison is arbitrary, as an example, the comparing unit 216 selects n arbitrary pixels from among the pixels in the area corresponding to the display position of the title bar position B, and compares the pixels values of the selected pixels with the pixel values of the corresponding pixels in the specific image. If all pixel values are matching, then it is determined that the specific image is completely matching with the image portion in the modification image which is displayed at the position specified in the specification information. In the example illustrated in FIG. 29, of the modification image, the image portion displayed in the area corresponding to the display position of the title bar portion B completely matches with the specific image (i.e., the image of the title bar portion B). As a result, the entire window Wx is not transferred to the client device 300.

Meanwhile, alternatively, without referring to the specification information, the comparing unit 216 can compare only the images and determine whether or not there is an image portion in the obtained modification image that matches with the specific image. In essence, when an image portion in the obtained modification image matches with the specific image; the entire modification image is not sent to the client device. On the other hand, when no image portion in the obtained modification image matches with the specific image, the modification image is sent to and displayed on the client device 300.

### (5) Fifth Modification Example

In the first embodiment, the obtaining unit 214 extracts, from a set of image data received from the image data generating unit 212, the portion (area) that has got modified as compared to the corresponding previous piece of image data and obtains the image displayed in the extracted portion as the modification image. However, that is not the possible case. Alternatively, for example, a modification image detecting unit can be disposed independent of the obtaining unit 214 for extracting, from each of a plurality of pieces of image data generated in a sequential manner by the image data generating unit 212, the image portion that has got modified as compared to the corresponding previous piece of image data and detecting the image displayed in the extracted portion as the modification image. Then, the obtaining unit 214 can obtain modification images from the modification image detecting unit. In essence, the obtaining unit 214 can be configured to obtain; from each of a plurality of pieces of image data generated in a sequential manner, the modification image that represents the image portion that has got modified as compared to the corresponding previous piece of image data.

In an identical manner, in the second embodiment too, the client device 300 can be configured to include the modification image detecting unit so that the obtaining unit 306 can obtain the modification images from the modification image detecting unit. Alternatively, the modification image detecting unit can also be disposed in the server device 200. In that case, the modification images detected by the modification image detecting unit are sent to the client device 300, in which the obtaining unit 306 obtains the modification images sent by the server device 200. Similarly, in the third embodiment too, the relay device 400 can be configured to include the modification image detecting unit so that the obtaining unit 403 can obtain the modification images from the modification image detecting unit. Alternatively, the modification image detecting unit can also be disposed in the server device 200. In that case, the modification images detected by the modification image detecting unit are sent to the relay device 400, in which the obtaining unit 403 obtains the modification images sent by the server device 200.

### (6) Sixth Modification Example

In the embodiments and the modification examples described above, various programs executed in each of the server device 200, the relay device 400, and the client device 300 can be saved on a computer connected to a network and downloaded from that computer via the network. Alternatively, those various programs can be provided in the form of a computer program product by storing them as installable or executable files on a computer-readable recording medium such as a compact disk read only memory (CD-ROM), a flexible disk (FD), a compact disk recordable (CD-R), or a digital versatile disk (DVD).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server device that performs communication with a client device, the server device comprising:
an obtaining unit configured to obtain, from each of a plurality of pieces of image data generated in a sequential manner, a modification image representing an image portion which has got modified as compared to corresponding previous piece of image data;
a storing unit configured to store therein a specific image representing an image portion that is not to be displayed on the client device;
a comparing unit configured to compare the modification image with the specific image; and
a sending unit configured to send, to the client device, the modification image not containing the specific image and not to send, to the client device, image portion in the modification image that match with the specific image.

2. The server device according to claim 1, further comprising a generating unit configured to generate the plurality of pieces of image data in such a way that the specific image is included in the modification image.

3. The server device according to claim 2, wherein the generating unit generates the plurality of pieces of image data in such a way that the specific image is displayed in a specific area in a flashing manner.

4. The server device according to claim 2, wherein the generating unit generates the plurality of pieces of image data in such a way that a display position of the specific image changes over time.

5. The server device according to claim 1, wherein the sending unit sends in advance, to the client device, reference image data that represents image data present immediately before starting the display of the specific image.

6. The server device according to claim 1, wherein the sending unit sends, to the client device, an image portion in the modification image that does not match with the specific image.

7. The server device according to claim 1, wherein, when the modification image contains the specific image, the sending unit does not send the modification image to the client device.

8. The server device according to claim 1, further comprising a receiving unit configured to receive the plurality of pieces of image data from an external device, wherein
the obtaining unit extracts, from each of the plurality of pieces of image data received by the receiving unit, a portion which has got modified as compared to corresponding previous piece of image data and obtains an image displayed in the extracted portion as the modification image.

9. The server device according to claim 1, wherein the obtaining unit obtains the modification image from an external device.

10. A client device that performs communication with a server device, the client device comprising:
an obtaining unit configured to obtain, from each of a plurality of pieces of image data generated in a sequential manner in the server device, a modification image representing an image portion which has got modified as compared to corresponding previous piece of image data;
a first storing unit configured to store therein a specific image representing an image portion that is not to be displayed;
a second storing unit configured to store therein reference image data that represents image data present immediately before starting the display of the specific image;
a comparing unit configured to compare the modification images with the specific image; and
a display control unit configured to generate, on the basis of a comparison result of the comparing unit and the reference image data, display image data that is image data representing an image to be displayed and that does not contain image portion in the modification image that match with the specific image, and display the display control data.

11. The client device according to claim 10, further comprising an updating unit configured to update the reference image data to the display image data.

12. An image transfer system comprising:
a server device;
a client device; and
a relay device that communicates with the server device and with the client device, wherein
the relay device includes:
an obtaining unit configured to obtain, from each of a plurality of pieces of image data generated in a sequential manner in the server device, a modification image representing an image portion which has got modified as compared to corresponding previous piece of image data;
a storing unit configured to store therein a specific image representing an image portion that is not to be displayed on the client device;
a comparing unit configured to compare the modification image with the specific image; and
a sending unit configured to send, to the client device, the modification image not containing the specific image and not to send, to the client device, image portion in the modification image that match with the specific image.
